(19) United States
(12) Patent Application Publication
(10) Pub. No.: US 2026/0018080 A1
(43) Pub. Date: Jan. 15, 2026

(54) DYNAMIC GENERATION OF PERSONALIZED CONTENT FOR ACCELERATED EXAM PREPARATION USING INTEGRATED PROGRAMMATIC AND SPECIALIZED GUIDED AND CONSTRAINED ARTIFICIAL INTELLIGENCE

(71) Applicant: 2hr Learning, Inc., Austin, TX (US)

(72) Inventors: Philip Hewinson, Woking (GB); Samy Aboel-Nil, Austin, TX (US)

(73) Assignee: 2hr Learning, Inc., Austin, TX (US)

(21) Appl. No.: 19/269,640

(22) Filed: Jul. 15, 2025

Related U.S. Application Data
(60) Provisional application No. 63/671,747, filed on Jul. 15, 2024.

(51) Int. Cl. G09B 7/08; G06Q 50/20

(52) U.S. Cl. CPC G09B 7/08; G06Q 50/205

(57) ABSTRACT

A personalized content generation method and system to guide and constrain an AI engine to generate personalized educational content for accelerating test preparation of a user based on the performance of a user in a mock test on an online learning platform is disclosed. The method starts with presenting a mock test related to a specific curriculum. User performance data, including mastery levels on various topics, is collected and analyzed. The data is mapped to historical exam data, identifying weak areas of the user. The system then determines the importance of these weak topics based on their frequency in past exams and their relevance to curriculum standards. The system generates prompts for the AI engine, guiding and constraining to create personalized educational content focused on these areas. The personalized content is delivered to the user in real-time, targeting topics where user's mastery level is low but is significant for exam.

### CROSS-REFERENCE TO RELATED APPLICATION(S)

This application claims the benefit under 35 U.S.C. § 119(e) and 37 C.F.R. § 1.78 of U.S. Provisional Application No. 63/671,747, which is incorporated by reference in its entirety.

### FIELD OF THE INVENTION

The present invention relates to the field of electronics, and more specifically to a personalized content generation system using AI (Artificial Intelligence) for accelerated exam preparation to optimize learning based on the mastery level of the user on various educational standards and weightage of the educational standards from the exams standpoint.

### BACKGROUND OF THE INVENTION

Digital learning platforms provide a centralized learning space for students to access educational content and resources. These platforms serve as a virtual classroom providing various content in different formats such as videos, lectures, interactive quizzes, discussion forums, and downloadable materials. Moreover, digital learning platforms allow students to learn at their own pace and convenience. Digital learning platforms are also utilized to conduct practice tests to assess student's knowledge. By taking multiple mock tests, the digital learning platform helps the students monitor their progress, self-assess their academic capabilities, understand the test format, and reduce anxiety on exam day.

Typically the practice tests provided on conventional digital learning platforms rely on static test formats presenting pre-stored questions and content to students, thus helping them strengthen their knowledge of given topics. While the educational content may help students prepare for the exams, the students may not understand the concepts thoroughly. As a result, the students become overwhelmed by the vast amount of content required to be proficient for the exams.

Traditionally, the practice test methods were delivered linearly, following a set curriculum without reflecting the student's knowledge of the curriculum. This approach can lead to gaps in understanding the strengths and weaknesses of the students. The traditional practice test methods rely on one-size-fits-all and assume that all the students learn similarly. However, a one-size-fits-all approach does not address individual learning needs, which can overwhelm some students while under-challenging others, leading to frustration or boredom.

Conventionally, the practice tests allow the students to attempt different questions to prepare for an exam. However, a lack of interactivity and real-time engagement may not provide immediate feedback or assessment. If a student feels stuck in a certain concept while attempting the questions, the student might have to seek help from the educators which can be time-consuming. The teachers might not be readily available, which can further add to the student's frustration while practicing a topic.

### SUMMARY

In at least one embodiment, a method of guiding and constraining an Artificial Intelligence (AI) engine to generate personalized educational content for accelerating test preparation of a user based on the performance of a user in a mock test on an online learning platform includes executing code using one or more processors of a computer system. Executing code causes the computer system to perform operations. Operations include presenting the mock test via a user interface on the online learning platform. The mock test includes multiple questions related to a selected teaching curriculum. Operations include receiving user performance data. User performance data includes the performance of the user on the mock test and mastery data indicating the level of mastery obtained by the user on various topics included in the teaching curriculum. Mastery data is based on the topics studied by the user before attempting the mock test. Operations include mapping the user performance data to exam data. Exam data includes multiple questions and corresponding topics that appeared in one or more previous exams. Mapping identifies one or more weak topics not yet mastered by the user but important from an exam standpoint. Operations include identifying the weightage of one or more weak topics based on the frequency of occurrence of the weak topics in previous exams and the relevance of weak topics to one or more standards of the teaching curriculum. Operations include generating prompts to guide and constrain the AI engine based on the identified weak areas to generate personalized content for accelerated exam preparation. Operations include transferring the prompts to the AI engine to generate the personalized content for the user on a real-time basis. Operations include receiving the personalized content for the user from the AI engine. The generated personalized content includes content related to the topics where the mastery level of the user is low, but the weightage of the topic to come in the exam is high.

In another embodiment, a system to guide and constrain an Artificial Intelligence (AI) engine to generate personalized educational content for accelerating test preparation of a user based on the performance of a user in a mock test on an online learning platform comprises one or more processors. The system includes a memory coupled to the one or more processors. The memory includes code. Executing code causes the one or more processors to perform operations. Operations include presenting a mock test via a user interface on the online learning platform. The mock test includes multiple questions related to a selected teaching curriculum. Operations include receiving user performance data using a data collector. User performance data includes the performance of the user on the mock test and mastery data indicating the level of mastery obtained by the user on various topics included in the teaching curriculum. Mastery data is based on the topics studied by the user before attempting the mock test. Operations include mapping the user performance data to exam data using a mapping module. Exam data includes multiple questions and corresponding topics that appeared in one or more previous exams. Mapping identifies one or more weak topics not yet mastered by the user but important from an exam standpoint. Operations include identifying the weightage of one or more weak topics based on the frequency of occurrence of the weak topics in previous exams and the relevance of weak topics to one or more standards of the teaching curriculum using a weightage calculation module. Operations include generating prompts using a prompt generator to guide and constrain the AI engine based on the identified weak areas to generate personalized content for accelerated exam preparation. Operations include transferring the prompts to the AI engine to generate the personalized content for the user on a real-time basis. Operations include receiving the personalized content for the user from a personalized content generation module. The generated personalized content includes content related to the topics where the mastery level of the user is low, but the weightage of the topic to come in the exam is high.

### BRIEF DESCRIPTION OF THE DRAWINGS

The systems and methods described herein may be better understood, and their numerous objects, features, and advantages are made apparent to those skilled in the art by referencing exemplary embodiments depicted in the accompanying figures. The use of the same reference number throughout the several figures designates a like or similar element.

FIG. 1 depicts an exemplary personalized content generation system for accelerated exam preparation based on the mastery level of the user on various educational standards and the weightage of the educational standards.

FIG. 2 depicts an exemplary personalized content generation process for accelerated exam preparation based on the mastery level of the user on various educational standards and the weightage of the educational standards.

FIG. 3 depicts a flowchart showing the steps of generating personalized content to accelerate the preparation of users for an exam.

FIG. 4 depicts an exemplary educational content distribution process, which is an embodiment of the personalized content generation process in FIG. 2.

FIG. 5 depicts a curriculum weightage-based content distribution process, which is an embodiment of the personalized content generation process in FIG. 2.

FIG. 6 depicts a feedback-providing process to the user based on the generated mock test, which is an embodiment of the personalized content generation process in FIG. 2.

FIG. 7 depicts a mock test generation process, which is an embodiment of the personalized content generation process in FIG. 2.

FIG. 8 depicts a real-time assistance-providing process to the user during a mock test, which is an embodiment of the personalized content generation process in FIG. 2.

FIG. 9 depicts an interaction process between the user and the real-time tutor for seeking guidance, which is an embodiment of the personalized content generation process in FIG. 2.

FIG. 10 depicts an educational content delivery process based on the weaker areas of the user, which is an embodiment of the personalized content generation process in FIG. 2.

FIG. 11 depicts a mock test analysis process, which is an embodiment of the personalized content generation process in FIG. 2.

FIG. 12 depicts a data structure for organizing data that is used to distribute the educational content based on the curriculum data.

FIG. 13 depicts a data structure for organizing data that is used to simulate the AI-generated mock tests.

FIG. 14 depicts a data structure for organizing data that is used to provide real-time assistance from a real-time tutor during the mock test.

FIG. 15 depicts a data structure for organizing data to generate a personalized educational content playlist.

FIG. 16 depicts an educational content generation and real-time assistance providing a process to the user giving the mock test, which is an embodiment of the personalized content generation process in FIG. 2.

FIG. 17 depicts an AI-generated mock test and accelerated learning process, which is an embodiment of the personalized content generation process in FIG. 2.

FIG. 18 depicts exemplary exam data displaying the number of questions that appeared in one or more previous exams.

FIG. 19 depicts an exemplary user interface disclosing the topic-wise details of the subject.

FIGS. 20-22 depict exemplary user interfaces disclosing the AI-generated mock test to the user using an online learning platform.

FIGS. 23-25 depict exemplary user interfaces disclosing a real-time tutor assisting the user in real time when the user gives an incorrect answer during a mock test.

FIG. 26 depicts an exemplary user interface disclosing the result of the mock test provided to the user.

FIGS. 27-29 depict exemplary user interfaces disclosing the targeted personalized content to the user after finishing the mock test, based on the incorrect answers and their weightage in the curriculum.

FIG. 30 depicts an exemplary network environment in which the exemplary personalized content generation system of FIG. 1 and the exemplary personalized content generation process of FIG. 2 may be practiced.

FIG. 31 depicts an exemplary computer system.

### DETAILED DESCRIPTION

The personalized content generation system and method set forth herein address technical issues with providing accelerated exam preparation based on the mastery level of the user on various educational standards and the weightage of the educational standards described herein. Conventionally, manual processes were used for exam preparation based on the mastery level of the user and were very tedious and time consuming. The present personalized content generation system and method utilize an automated system that does not merely automate a manual process or use a conventional system in a conventional way. The present personalized content generation system and method utilize one or more artificial intelligence (AI) engines and integrate programmatic process management to technologically guide and constrain the one or more AI engines to provide exam preparation based on the mastery level of the user in a completely different way than both any manual process and different than normal use of programs and AI engines. Utilizing specially engineered guidance and control to direct an AI system in solving the technical problems presented below, which require a technical solution. The personalized content generation system and method described below are not simply engaging a computer to carry out conventional mental processes, but rather change how computers (and AI systems, specifically) operate to achieve the generation results that were not previously possible or were substantially inefficient prior to the personalized content generation system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended usc.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the personalized content generation system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The personalized content generation system and method generate decomposed, technically engineered AI prompts to include selected and integral AI engine guidance and constraints. The technically engineered prompts are generated and guided with programmatic, automatic inputs specifically designed to unconventionally guide and constrain an AI engine to provide exam preparation based on the mastery level of the user, perform quality control to retain or automatically discard outputs that do not meet guidance and constraints, and make the desired outputs available for use, such as use by computer system applications. In at least one embodiment, the problem to be solved by the integrated programmatic and AI engine personalized content generation system and method is uniquely and unconventionally decomposed, and AI prompts are used to solve the decomposed problem. Furthermore, the programmatic inputs to the decomposed AI prompts provide guidance for providing accelerated exam preparation based on the mastery level of the user on various educational standards and the weightage of the educational standards

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the personalized content generation system and method described herein. Thus, the present personalized content generation system and method described implement an integration of programmatic management over decomposed prompts with engineered AI engine guidance and constraints to affect an improvement in AI, programmatic AI management, and AI integrated with programmatic management technology. The present personalized content generation system and method allow computer systems to include programmatic management, one or more AI engines, and one or more data sources to provide accelerated exam preparation based on the mastery level of the user on various educational standards and the weightage of the educational standards that previously could not be produced with conventionally prompted AI engines or could only be produced by humans utilizing a completely different, time consuming, and tedious process. The personalized content generation system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models-Algorithms that analyze data, recognize patterns, and make predictions.
2. Neural Networks-Deep learning architectures that mimic the human brain for tasks like image and speech recognition.
3. Data Processing Module-Handles raw data input, transformation, and feature extraction.
4. Inference Engine-Applies trained models to make real-time decisions based on new data.
5. Optimization Algorithms-Improves model efficiency, reducing errors and improving predictions.
6. Natural Language Processing (NLP) Module-Enables AI engines to understand, interpret, and generate human language (e.g., chatbots, voice assistants).
7. Computer Vision Module-Allows AI to interpret and analyze images or videos.
8. Reinforcement Learning Mechanism-Helps AI learn from trial and error, optimizing performance over time.
9. API Interface-Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

Notwithstanding any provision to the contrary or anything to the contrary in the below pages, the below pages are not limiting and do not describe all embodiments of the personalized content generation systems and methods. For example, use of the term “invention” does not limit or require the referenced certain features to be present in all embodiments of the invention. Use of absolute-type terms, such as “required,” “must,” “only,” “important,” and so on are not limiting of all embodiments of the personalized content generation systems and methods and not to be construed as limiting of the embodiments of the personalized content generation systems and methods described above.

A personalized content generation method and system to guide an AI engine to generate personalized educational content for accelerating test preparation of a user based on the performance of a user in a mock test on an online learning platform is disclosed. The online learning platform features a test prep mode. The test prep mode feature allows the user to take a mock test when the user prepares for the exam. The mock test includes multiple questions which are important from the exam standpoint. The user interacts with these mock tests and when the user answers a question incorrectly a real-time tutor appears on the screen. The real-time tutor explains the concept related to the educational content that the user got wrong. The user can also interact with the real-time tutor using a chatbot. As the user responds to the mock test, the user performance data is stored within the memory of the online learning platform. The mastery data is stored in the memory based on the knowledge the user has gained before appearing in the mock test.

A content generation system, operatively coupled with the online learning platform is designed to optimize study sessions by aligning the educational content provided to students with the proportional importance of each topic as represented on the exams. The content generation system optimizes the study sessions and tests based on the inputs received from the online learning platform which includes the user performance data and the mastery data. A test-proportionate content planning module, integrated within the content generation system, analyzes the student performance across various standards and topics. It then analyzes the weightage of these topics on the actual exams. Based on this analysis, it distributes study content to the student, prioritizing areas where the student's mastery is low but the exam weightage is high.

The AI engine is used to generate a test and personalized content on the online learning platform. The AI engine creates personalized test simulations that adapt to the student's learning progress, providing targeted practice where it's needed most. The AI engine generates multiple multiple-choice questions (MCQs) that assess the student's mastery over specific standards, topics, or units.

The AI engine generates a personalized playlist for the user. The algorithm analyzes the student's test results to identify weak areas. It then compiles a playlist of learning materials that target these areas, providing an efficient path to mastery. The system generates a targeted practice to enhance the educational experience and accelerate the learning for test preparation.

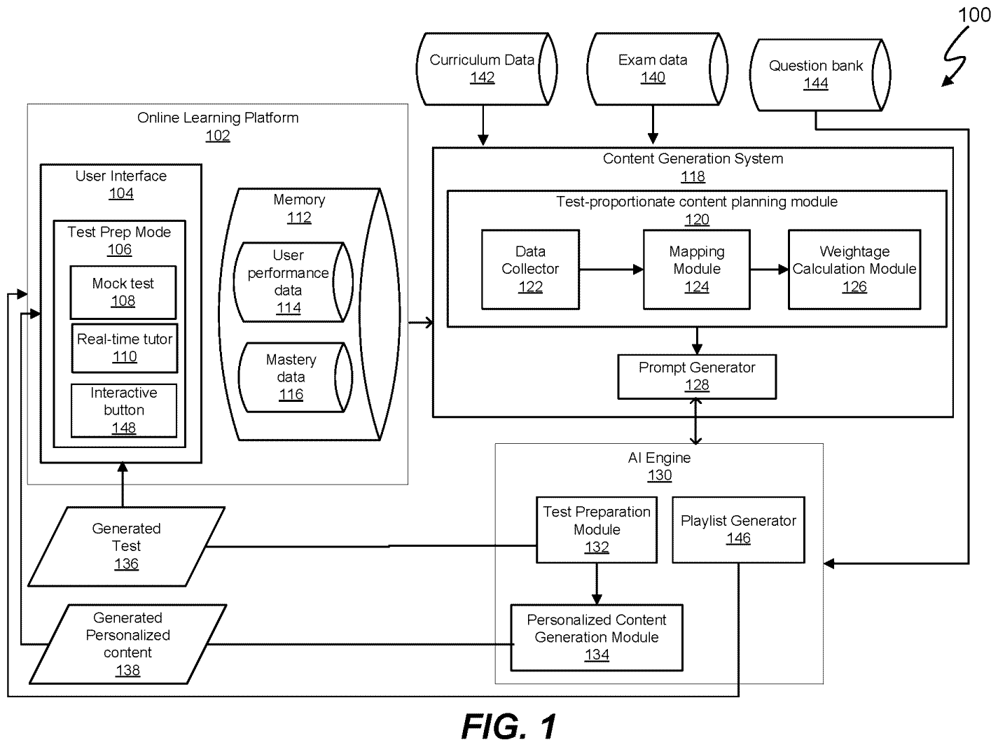

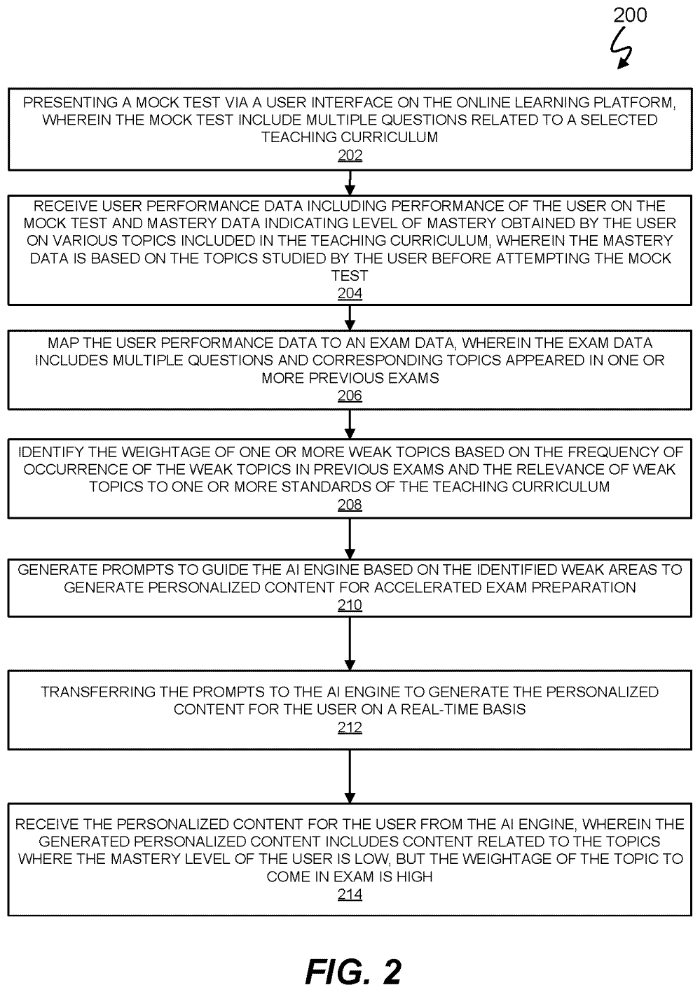

FIG. 1 depicts an exemplary personalized content generation system 100 for accelerated exam preparation based on the mastery level of the user on various educational standards and the weightage of the educational standards. FIG. 2 depicts an exemplary personalized content generation process 200 for accelerated exam preparation based on the mastery level of the user on various educational standards and the weightage of the educational standards utilized by the personalized content generation system 100.

Referring to FIGS. 1 and 2, in operation 202, a user interface 102 integrated within an online learning platform 102 provides a mock test 108 to the user. The mock test 108 provided to the user includes multiple questions related to a selected curriculum data 142.

The user interacts with the online learning platform 102 and is presented with a mock test 108 in a test prep mode 106 feature of the online learning platform 102. The test prep mode 106 of the online learning platform 102 consists of different mock tests 108 presented to the user based on the curriculum data 142. Each curriculum is defined by a different course such that each course includes multiple units and each unit represents multiple topics. Each topic is defined by multiple standards. The test prep mode 106 helps the user to prepare for different exams and score higher in an exam within a short period. In one of the embodiments, the test prep mode 106 can be used for the preparation of the AP exam, SAT, GRE, or any professional certification exams. As the user builds the knowledge on a specific curriculum, the user can take a mock test 108 to accelerate the process of learning and achieving high scores in the exam.

The test prep mode 106 within an online learning platform 102 includes different courses of the curriculum data 142. Each course within the test prep mode 106 is split into several units, where each unit includes different mock tests 108. For instance, AP biology test prep mode 106 is divided into nine units such that each unit represents questions that are important from an exam point of view. The questions within the test prep mode 106 are more specific to the standards of each topic.

The mock tests 108 are short, byte-size tests with a duration of about 5-10 minutes presented to the user in the test prep mode 106 feature of the online learning platform 102. The mock tests 108 represent different questions relevant to the curriculum data 142. For instance, if a user wants to prepare for an AP biology exam the user will be presented with at least 8-10 questions about AP biology which are important from an exam point of view.

As the user accesses the mock test 108 presented on the online learning platform 102 including different questions relevant to that course. When the user answers incorrectly a real-time tutor 110 appears on the online learning platform 102. The real-time tutor 110 is an AI-generated virtual character with detailed knowledge of the educational content which provides a video explanation of the question, which the user got wrong. The real-time tutor 110 guides the user on the educational content that the user got wrong. The real-time tutor 110 which guides the user is in correspondence to the educational content or questions provided to the user.

The real-time tutor 110 is trained in educational content to provide accurate and helpful explanations. For instance, if John is preparing for the AP US history exam and answers a question about the Civil War incorrectly, John can pause the mock test 108 and learn from real-time tutor 110. A video of Abraham Lincon pops up explaining the concept to clarify his doubts.

The real-time tutor 110 can also appear if the user asks for guidance via an interactive button 148 during an online learning session. The interactive button 148 is integrated within the user interface 104 of the online learning platform 102. The user can access the interactive button 148 when he/she is facing difficulty in understanding a topic.

In at least one of the embodiments, the interactive button 148 can be a chatbot, which can be used to chat with the real-time tutor 110 to clear doubts regarding the educational concept. The user can ask further questions in the chat. The real-time tutor 110 provides immediate feedback to the user to clarify the doubts of the user.

In operation 204, a data collector 122 fetches user performance data 114 including the performance of the user in the mock test 108 and mastery data 116 indicating the level of mastery obtained by the user on various topics included in the curriculum data 142 The mastery data 116 is based on the topics studied by the user before attempting the mock test 108.

The mock test 108 is displayed to the user via test prep mode 106 on the user interface 104 of the online learning platform 102. The user attempts the mock test 108 and the user's response to the mock test 108 is stored within the memory 112 of the online learning platform 102. The user performance data 114 includes the user's test results which includes the score obtained by the user in the test. In one of the embodiments, the test result may be displayed in the form of grades, and performance metrics. The user performance data 114 may also include how the user interacts with the real-time tutor 110. As the user interacts with the real-time tutor 110 the online learning platform 102, the user interaction is also stored to identify the areas where the user is facing any problem. For instance, if a user is studying for an AP biology exam and is unable to understand the concept even after the explanation provided by the real-time tutor 110, the concept is marked as unmastered in memory 112.

As the user answers the questions correctly, it indicates that the concepts of the user are clear for that specific educational concept. If the user answers the question incorrectly, it indicates that the user is facing difficulty in understanding the educational concepts. The user performance data 114 helps to identify the weak areas of the user. The user performance data 114 based on the correctness of the questions in the mock test 108 is then stored in the memory 112 of the online learning platform 102.

The online learning platform displays two areas of navigation; a study mode and the test prep mode 106. On selecting the study mode the user gets educational content to attain the mastery of the corresponding topic. The user selects the course which he/she wants to study. For instance, if the user wants to study AP biology, the online learning platform 102 presents the relevant content to the user corresponding to AP biology. The AP biology course includes several standards. Each standard defines a particular topic for that course. The user interacts with these standards to attain mastery. The user is presented with the content in the form of MCQs, match the following, truth or lic, and fill-in-the-blanks which makes the educational content more interactive. Based on the correctness and interaction of the user with the content in the study mode, the mastery level of the user is achieved.

The mastery data 116 is then stored in the memory 112 of the online learning platform 102. The mastery data 116 includes the knowledge the user has before attempting the mock test 108. The mastery level of the user gets updated on a real-time basis as the user interacts with the content presented on the online learning platform 102. As the user interacts with the content presented on the online learning platform 102, the mastery level of the user is updated and is dynamically stored in the memory 112 of an online learning platform 102 in real-time.

In operation 206, a mapping module 124 to map the user performance data 114 to exam data 140. The exam data 140 includes questions related to corresponding topics that have appeared in one or more previous exams, thereby identifying one or more weak topics that are not yet mastered by the user but are important from an exam standpoint.

The mapping module 124 is integrated within a content generation system 118. The content generation system 118 is operatively coupled with the online learning platform 102 and AI engine 130. The content generation system 118 is responsible for generating content to be presented to the user via the online learning platform 102. The content can be optimized based on the interaction of the user with the online learning platform 102.

A test proportionate content planning module 120 within the content generation system 118 utilizes an algorithm to calculate the weightage of different standards within the exam to plan the content to be presented to the user. The data collector 122 within the test-proportionate content planning module 120 receives the user performance data 114 from the memory 112 of the online learning platform 102. The data collector 122 further analyzes the user performance data 114 using a machine learning algorithm to identify weak areas of the user. The weaker areas are identified based on the number of interactions a user does with each topic, the number of attempts per question, time spent on each quiz, click patterns, responses to quizzes, and interaction with the educational content.

The test proportionate content planning module 120 fetches exam data 140 to identify the topics and standards that are important from an exam standpoint. The exam data 140 includes multiple questions and corresponding topics which appeared in or more previous exams. In one of the embodiments, the exam data 140 can be collected from an open source, college board, and Next Generation Science Standards (NGSS).

The exam data 140 is sorted based on keywords, and key events to clean the data. The exam data 140 includes a list of courses such as AP bio, AP History, AP environmental sciences, and so on. Each course within the exam data 140 is further divided into topics and standards. For instance, AP biology has several units and each unit is divided further into various standards where unit 1 of AP biology represents 53 standards. Standards are defined as independent topics based on which the questions will be generated in the mock test 108.

The mapping module 124 within the test-proportionate content planning module 120 maps the user performance data 114 to exam data 140. Mapping is done to identify one or more topics that are not yet mastered by the user but are important from an exam standpoint. The mapping module 124 fetches data from data collector 122.

For instance, John gives a mock test 108 related to AP biology. Based on the interactions and incorrect answers of John the data collector 122 identifies that John lacks educational content relating to “composition of monomers”. The mapping module 124 fetches this information and maps the standard “composition of monomers” with the questions presented in the exam data 140. The exam data 140 includes questions related to “composition of monomers” indicating the importance of this topic within the exam which is yet not mastered by John.

In operation 208, a weightage calculation module 126 calculates the weightage of one or more topics based on the frequency of occurrence of the topics in previous exams, and the mastery of the user on the topics is identified.

The weightage calculation module 126 within the test proportionate content planning module 120 identifies the weightage of various standards across the exam. The mapping module 124 maps the weak areas of the user with their occurrence in the exam data 140. This information is then fed to weightage calculation module 126. The weightage calculation module 126 identifies the weightage of these topics based on the occurrence of these topics in previous exams.

The exam data 140 includes information on standards and their weightage on the exam and a list of study materials tagged with standards. The weightage calculation module 126 fetches this data from exam data 140 to identify the importance of each topic in the previous exams. For instance, in AP biology course unit 1 has 53 standards such that each standard has a different weightage from the exam point of view and the AP biology exam has 65 questions from the whole course. The AP biology topic 1.1 has 3 questions from different standards indicating the importance of these standards from the exam point of view. In the end, unit 1 represents only 8 questions out of 53 which are important. This data is fed to the weightage calculation module 126.

The weightage calculation module 126 identifies the frequency of the topics and standards occurring in the previous exams. For example, if a user indicates low mastery in one topic, however, the topic comes up frequently in the exam. The topics are arranged hierarchically based on their weightage in the exam and user low mastery. The questions with high weightage and low user mastery levels are arranged first followed by others.

The codes and functions mentioned in the pseudo-code of the personalized content generation system 100 for accelerated exam preparation based on the mastery level of the user on various educational standards and the weightage of the educational standards to calculate the weightage of the educational content are explained below in correspondence to the above-mentioned details.

The function ‘distribute_content_based_on_exam_proportions (exam_standards, study_material)’ allocates study materials according to the importance of each standard in the exam. It takes two inputs: ‘exam_standards’, a dictionary detailing the proportional weight of each standard in the exam, and ‘study_material’, a list of materials tagged with these standards. The function iterates through each standard, filters relevant materials, and sorts them based on how well they align with the standard's weight, ultimately compiling an ordered list of study materials prioritized for exam preparation.

The inputs from the test-proportionate content planning module 120 are used to generate insights for prompt generation. As the user interacts with the online learning platform 102, the mastery data 116 is stored within memory 112 of the online learning platform 102. The user's interaction is mapped using the mapping module 124 against the curriculum standards. The exam data 140 provides the curriculum standard data to generate questions and interpret the user's response.

In operation 210, a prompt generator 128 generates the prompts to guide and constrain the AI engine 130 based on the identified weak areas are generated to personalize content for accelerated exam preparation.

Before prompt generation, a prompt engineer generates a prompt structure along with the rules and guidelines to generate the prompt. These rules and guidelines along with the prompt structure are sent to the prompt generator 128, which fetches the analyzed data from the test-proportionate content planning module 120 and populates the prompt structure.

One embodiment of the prompt structure along with the rules and guidelines to generate the prompt for generating MCQs (Multiple Choice Questions) provided by the prompt engineer to the prompt generator 128 is given below:
Context
You are a multiple-choice question (MCQ) generator that produces a very difficult question for students, to assess whether they have mastered the given Historical Development for AP US History. You will be given an ‘Historical Development’, ‘Cluster’, ‘Domain’, ‘Historical Thinking Skill’, an ‘Example’ delimited by ∥|, and ‘Key Concept List’ delimited by ″″″.
Task
1. Using the Rules listed below, write a very challenging AP US History exam MCQ similar in structure and style to the ‘Example’, while focusing on the key term: “Ku Klux Klan” to directly assess student's knowledge of the ‘Historical Development’. The generated question must also assess student's ability to apply ‘Historical Thinking Skill’.
2. You may use the ‘Cluster’, ‘Domain’, and ‘Key Concept List’ for additional historical context.
3. Write 4 answer options (A, B, C, D) for the question. Ensure that only one option is true while the remaining options are false. Include short explanations for each answer choice, explaining why the answer choice is correct or incorrect.
4. Create one Learning Content that helps users learn everything they need to answer the question. The Learning Content should guide the student toward the right answer without directly giving away the correct answer choice. Also, the learning content should NOT use parentheses; any additional or relevant information typically inserted within parentheses should be coherently embedded into the sentence.
5. Rate the outputs on a scale of 1-10 for the following criteria:
   question_relevance: how relevant is the question to the historical development?
   question_difficulty: how difficult is the question?
   learning_content_quality: How effective is the learning content in guiding the student in the correct direction?
Output Template
Question: The generated MCQ Question
Options: A list of the four answer choices, along with an explanation and a correctness marker which marks the single correct answer as true
Learning Content: The learning content required to understand the question
Rating: The ratings for the generated question. All ratings MUST be an integer between 1 and 10
Rules
Word Count Rules:
Answer Explanation: 20 words or less
Learning Content: 80 to 100 words, 4-6 sentences
MCQ Generator Rules:
The MCQ generator must produce a very challenging MCQ that demands an in-depth understanding of the ‘Historical Development’, and contains plausible incorrect answer choices.
The MCQ generator places less emphasis on simple recall and more emphasis on evaluating student's understanding of the ‘Historical Development’ and the ability to apply the ‘Historical Thinking Skill’.
The MCQ generator must not directly reference the ‘Historical Development’, ‘Cluster’, ‘Domain’, and ‘Key Concept List’ in the question.
The MCQ generator should NOT use the specific words “course”, “historical development”, “cluster”, “standard”, “learning objective”, or “historical thinking skill” in the question, answer choices, learning content, or explanations.
The MCQ generator must generate four total answer choices (A, B, C, D) and ensure that ONLY one answer choice is correct.
The MCQ generator must ensure that all answer choices are consistent in length, using the same number of words, phrases, and clauses across all options.
Incorrect Answer Choices Rules:
All incorrect answer choices should be challenging to eliminate, and not use characteristics that are uniformly opposite to those of the correct answer. Incorrect answer choices should offer subtle variations, compelling the student to employ knowledge, understanding, and reasoning to distinguish between the correct and incorrect correct answer choices.
All incorrect answer choices should be plausible, realistic, and challenge common student misconceptions while maintaining a consistent narrative or theme as seen in the correct answer. High quality incorrect choices should help to test for a comprehensive understanding of the content.
All incorrect answer choices should be closely related to the question content, presenting plausible but incorrect alternatives based on common misconceptions or errors in reasoning.
All incorrect answer choices, while maintaining a consistent narrative or theme as seen in the correct answer, can contain some truths but should ultimately lead to a wrong conclusion if chosen.
Avoid the use of extreme language or absolute terms in incorrect answer choices, so the incorrect answer choices are NOT easier to eliminate.
Do NOT use phrases like “all of the above,” “none of the above,” and phrases that reflect absolute positions like “always,” “never,” “none,” “all,” and “universally” for the incorrect answer choices.
Learning Content Rules:
The Learning Content must always begin with “Here's what you need to know”.
The Learning content should NOT use parentheses. Any additional or relevant information typically inserted within parentheses should be coherently embedded into the sentence.
The Learning Content must provide educational value, summarize necessary information to solve the question, and support the student's understanding.
The Learning Content should NOT directly reveal the correct answer or reference incorrect answer choices as negative or incorrect examples. Its purpose is to help the user understand the educational concept and apply their knowledge.
The Learning Content must NOT use the exact wording used in the correct answer choice.
The Learning Content must NOT make any reference to the Historical Thinking Skill.
Core Input
Historical Development:
Historical Thinking Skill:
Cluster:
Domain:
Key Concept List:
Example: ∥| Question:
Option A:
Answer:
Explanation:
Option B:
Answer:
Explanation:
Option C:
Answer:
Explanation:
Option D:
Answer:
Explanation:

Another embodiment of the prompt structure along with the rules and guidelines to generate the prompt for generating MCQs (Multiple Choice Questions) provided by the prompt engineer to the prompt generator 128 is given below:
Prompt used to generate AP Test Simulation questions for AP United States History. For tutor support, the same prompt is used as in ‘Personalized AI generated video responses’
<IMPORTANT_NOTES>
Before you complete the TASKS, think about what constitutes a good stimulus-based MCQ.
   Think about how the examples in the EXAMPLE CONTENT represent high-quality AP exam questions.
   Think about how these examples don't ask for a summary of the excerpt but rather integrate the excerpt with a question that tests a higher-level understanding of the AP World History curriculum.
   Think about how these examples cannot be answered simply by reading the passage.
A student needs to have knowledge of AP World History content.
   Think about how the primary sources are from the time period given in the “Cluster”
   Think about how the incorrect answer options (i.e., the distractors) do not use absolute language, which makes them plausible. This is crucial when developing distractors.
Absolute language includes words or phrases that make an extreme, unqualified, or unconditional statements (e.g., “always,” “never,” “completely,” “immediate,” “total,” “universally,” “all,” “complete,” “exclusively,” etc.).
   Think about how the Answer Option length can be an indicator of correctness, so it's best to have the Answer Options be of a similar length.
   Think about how the examples follow all of the RULES.
Before you output the generated MCQ, output your analysis in <thinking> tags.
</IMPORTANT_NOTES>
<TASKS>
Follow these steps to create a high-quality Batch MCQ. Wrap your reasoning process for each step inside <mcq_development> tags. The MCQs must align with the Curriculum Details, requiring students to synthesize context from the stimulus with their broader historical knowledge. While the stimulus can provide context, answering correctly must depend on applying external historical knowledge that is not explicitly stated in the stimulus text.
1. First, identify a substandard from the provided curriculum that aligns with the Substandard given at the end of this prompt. This substandard MUST be used for at least one of your generated MCQs.
2. Review the curriculum information carefully, noting the Learning Objectives, Historical Developments, Key Concepts and Substandards.
3. Analyze Curriculum Content and Research Historical Context:
   Summarize the key themes, concepts, and vocabulary terms from the curriculum. List at least 5 important elements and explain their relevance to the curriculum.
   Identify at least three key points about relevant historical events, figures, and cause-effect relationships. For each point, explain how it relates to the curriculum.
4. Follow the STIMULUS RULES to generate an authentic excerpt or excerpts from a primary or secondary source that align with the time period and historical concepts given in the User Input.
   The stimulus should be contain 1 primary source or 1 secondary source. It shouldn't contain both.
   These excerpts should be historically accurate, relevant to the AP United States History content, and appropriate for high school students.
   You must say these excerpts are “adapted” from the original work.
   If the excerpt is a primary source, it must be dated from within a time period covered within the curriculum
5. Brainstorm potential questions linked to specific skills.
   Using the below skills, brainstorm at LEAST 8 potential MCQs. Each question should assess one of the following skills:
<SKILLS>
SKILL ID: SKILL DESCRIPTION
1.A: Identify a historical concept, development, or process.
1.B: Explain a historical concept, development, or process.
2.A: Identify a source's point of view, purpose, historical situation, and/or audience.
2.B: Explain the point of view, purpose, historical situation, and/or audience of a source.
2.C: Explain the significance of a source's point of view, purpose, historical situation, and/or audience, including how these might limit the use(s) of a source
3.A: Identify and describe a claim and/or argument in a text-based or non-text-based source.
3.B: Identify the evidence used in a source to support an argument.
3.C: Compare the arguments or main ideas of two sources.
3.D: Explain how claims or evidence support, modify, or refute a source's argument.
4.A: Identify and describe a historical context for a specific historical development or process.
4.B: Explain how a specific historical development or process is situated within a broader historical context.
5.A: Identify patterns among or connections between historical developments and processes.
5.B: Explain how a historical development or process relates to another historical development or process.
</SKILLS>
Ensure the questions align with the curriculum and selected skills. Explicitly state how the questions connect to the curriculum and chosen skills.
a. If the selected skill is 1.A, the question MUST NOT ask for answers that can be found in the passage. This skill requires the student to use their outside knowledge of AP United States History content.
b. If the selected skill is 2.B, questions about an author's point of view MUST NOT include the author's actual position in the question because their position is one of the potential answers to the question. This skill requires students to use the context given in the source accreditation to answer the question.
c. Rank each question on a scale of 1-5.
6. Generate at least 4 MCQ Questions that connect with this Stimulus and covers multiple units of the curriculum. One of those units MUST be the input unit
   The Question should test a student's ability to complete the Objective.
   The content must be factually accurate.
   The Question must mirror the rigor, complexity, and style of AP United States History exam questions.
   At least 4 of the questions MUST directly reference the stimulus. These questions can reference one section/paragraph of the stimulus or all of it.
   Ensure the MCQ aligns with the style and structure of the example questions.
   The Question must require students to apply historical knowledge and critical thinking skills beyond mere reading comprehension. It must not be answerable solely by analyzing the information provided in the Stimulus.
   Students should need to synthesize information from the Stimulus with their broader understanding of historical events, concepts, or trends to arrive at the correct answer.
   The Question must not directly mirror the language of the Substandard or Objective.
7. Develop four Answer Options and Answer Explanations:
   There should be one correct answer, and three plausible incorrect answer options (i.e., the distractors).
   The distractors should NOT use absolute language (e.g., “always,” “never,” “completely,” “immediate,” “total,” “universally,” “all,” “complete,” “exclusively,” etc.). This would make the correct answer easily stand out.
   The Answer Options should be of a similar length so the correct answer does not stand out.
   Include a detailed explanation of why the correct Answer Option is correct.
   Include a detailed explanation for why each distractor is incorrect, addressing any potential mistakes in understanding and applying the course contents.
8. Follow the LEARNING_CONTENT_RULES to create learning content (80-100 words) for each question that explains the correct answer, makes specific references to the MCQ, and provides strategies for answering similar questions.
9. Format your final response using the following structure:

```
<OUTPUT_TEMPLATE>
<mcq_development> [All of the content from the mcq_development
tags]</mcq_development>
<stimulus_text>[stimulus text and source attribution]</stimulus_text>
<questions>
  <question>[Repeat foreach one of the 3 to 5 questions in this batch MCQ]
    <question_text>[The multiple-choice question]</question_text>
    <answer_options>[The list of answer choices, with their respective ID,
correct/incorrect and explanations]</answer_options>
    <primary_skill_covered>[the primary skill assessed by its
id] </primary_skill_covered>
    <primary_standard_covered>[the ID of the substandard covered by this MCQ. This
value must be one of Substandards in the given
curriculum] </primary_standard_covered>
  <primary_standard_covered_description>[the Description of the substandard covered
by this MCQ. This value must be one of Substandards in the given curriculum and
MUST be the one corresponding to the ID in
primary_standard_covered] </primary_standard_covered_description>
  </question>
</questions>
</OUTPUT_TEMPLATE>
</TASKS>
Batch MCQ - APUSH - Text SB - Exampleslatest
<RULES>
<STIMULUS_RULES>
<guidelines>
```

1. Ensure historical accuracy in terms of facts, dates, and context.
2. Match the writing style and vocabulary to the time period and source type.
3. Include relevant historical details that reflect the complexity of the topic.
4. Avoid anachronisms or modern perspectives in historical contexts.
5. Maintain an appropriate length for an AP exam stimulus (typically 100-200 words).
6. Ensure that the excerpt is connected to the Substandard, Objective, and MCQ
7. If using two sources, both sources must be either primary or secondary, don't mix sources. If there are two sources, the first source text MUST be labeled “Source 1” and the second source text MUST be labeled “Source 2.”
8. If there are two sources, the first source text must be labeled “Source 1” and the second source text must be labeled “Source 2.”
9. If there are two sources, they need to present different or conflicting information. They should not convey the same content.
Format your response as follows:
1. Begin with the excerpt in quotation marks.
2. If it is a primary source, give the following information: the type of work the excerpt is from (a letter, a law code, a royal decree, etc.), who the excerpt is from, and their role, and end with the date. If it is a secondary source, give the following information: the author, their role, the title of the work that the excerpt is from, and the type of work followed by the date of publication.
3. You must say the work is “adapted” from the source
To ensure historical accuracy and authenticity:
1. Use primary and secondary sources from reputable historical archives or academic publications as references.
2. Incorporate appropriate vocabulary, idioms, and writing styles for the time period and source type.
3. Double-check all facts, dates, and names for accuracy.
After generating your excerpt, review it to ensure it meets the following criteria:
1. Historical accuracy and authenticity
2. Relevance to AP United States History curriculum input
3. Appropriate length and complexity for high school students
4. Relevance to the generated MCQ
5. The source says “adapted from”
6. If the excerpt is a primary source, the date is from the time period given in the input's “Cluster”
7. If the excerpt contains more than one source, they must ALL be primary or secondary If necessary, refine your excerpt to better meet these criteria.
</guidelines>
<stimulus_examples>
<example_1>
“As the years passed and the plantation grew ever larger, I witnessed a cruel transformation of our lives. Where once my family had worked together, tending to our small plot and sharing meals, now we were torn apart. My father was sent to the far fields, my mother to the big house, and I to the cotton rows. We no longer saw each other from sunup to sundown. The overseer's whip became our constant companion, driving us to work harder, longer, with no regard for our bonds of kinship. The master's greed knew no bounds, and as more land was cleared for cotton, more of us were brought in chains. I remember the day when my sister was sold away, her cries piercing the air as she was dragged to the auction block. The plantation had become a merciless machine, grinding away at our humanity, destroying the very fabric of our families. Even in our quarters, we could no longer freely gather or practice our traditions. The old ways of our people were fading, replaced by the harsh rhythms of the plantation's endless hunger for profit.”
Adapted from the autobiography of Solomon Tanner, a former enslaved person who lived on a cotton plantation in Georgia from 1835 to 1865.
</example_1>
<example_2>
“In the great city of Khanbaliq, where the Grand Khan holds his court, I, Marco Polo, have witnessed markets teeming with marvels from every corner of the known world. The streets are lined with stalls where merchants from distant lands offer their wares. Silks of the finest quality, so delicate they can pass through a ring, are displayed alongside porcelains of such exquisite craftsmanship that they appear translucent in the sunlight.
Spices from the Indies fill the air with their pungent aromas-cinnamon, ginger, and pepper, each more valuable than gold in the lands of my birth. I have seen pearls from the southern seas, larger than any found in Venice, and jade ornaments carved with such skill that they seem to breathe with life.
What astounds me most is the bustling activity of foreign merchants. Arabs, Persians, and even men from the distant realms of Franks conduct their trade freely, protected by the Khan's laws. They bring horses from Arabia, ivory from Africa, and gems from Ceylon, all to exchange for the coveted goods of Cathay. The Khan encourages this commerce, for it brings great wealth to his empire and spreads the renown of his rule to the farthest reaches of the earth.”
Adapted from ‘Il Milione’ (The Travels of Marco Polo), a travelog by Marco Polo, a Venetian merchant and explorer who spent many years at the court of Kublai Khan in
China, c. 1300 CE.
</example_2>
</stimulus_examples>
</STIMULUS_RULES>
<QUESTION_RULES>
   Do not start the Question with “based on the passage.”
   Ensure the Stimulus is relevant to the Question
   Ensure the Question is directly testing a student's ability to demonstrate understanding of historical concepts
   The Question MUST NOT use first or second-person language.
   Do not use the word “stimulus” in the Question. If the Question directly refers to the Stimulus, it should call it a “passage.”
   Not all questions will use “as described in the passage,” you may point the student to a specific paragraph by using expression like “in the third paragraph” or “As outlined in the second paragraph” when appropriate
   The MCQ should be free from spelling and grammatical errors, ensuring professionalism and clarity. American spelling must be used.
   There must be exactly one factually accurate answer option. The correct answer must require application of historical knowledge beyond the information provided in the excerpt(s). The correct answer must not mirror any language used in the excerpt(s).
   The distractors must be plausible. Distractors must be distinct and lead students to demonstrate their understanding (or misunderstanding) of the substandard.
   The explanations for both the correct and incorrect answers must be clear and address potential misconceptions effectively. They should help reinforce the correct concept and clarify why the other choices are wrong.
   The Question must require students to apply their knowledge of the historical period to information presented in the Stimulus, rather than simply locating and repeating information from the excerpt.
   Be sure to review all examples for a reference on how AP style questions are written. The Example Question provided in the Curriculum Details can be used as a reference for how the Substandard might be assessed, but its content must not be mirrored in the final question.
   The Question must not be a matter of reading comprehension skills. It must test the students' broader understanding of the curriculum.
   The Question must not directly mirror the language of the Substandard.
   The distractors must not use absolute language (e.g., “always,” “never,” “completely,” “universally,” “exclusively,” “solely,” etc.) that would distinguish them from the correct answer.
   The Question must not use the word “stimulus”. If the Question directly refers to the Stimulus, it should refer to it as the “excerpt.”
The Question must not:
   Be answerable through reading comprehension of the excerpt alone
   Ask students to simply identify or restate information directly stated in the excerpt
   Focus solely on analyzing the internal logic or structure of the excerpt
The question must use the same language, sentence structure and expressions as the AP exams.
</QUESTION_RULES>
<ANSWER_OPTION_RULES>
   Ensure that there is only one correct answer among the choices and that it is factually accurate. The correct answer should directly address the question based on the Substandard.
   The incorrect answer options (i.e., the distractors) should be plausible. Distractors should be diverse, non-repetitive, and lead students to demonstrate their understanding (or misunderstanding) of the concept.
   The answers must use the same language, sentence structure and expressions as the AP exams.
   The distractors must not use absolute language such as “exclusively,” “solely,” “always,” “never,” “none,” “every,” “completely,” “immediately,” “absolutely,” etc. This is a critical criterion and must be strictly adhered to. For example:
Incorrect: “The emperor always prioritized military conquest.”
Correct: “The emperor often prioritized military conquest.”
   The explanations for both the correct and incorrect answers should be clear, thorough. They should help reinforce the correct concept and clarify why the other choices are wrong.
   Consider deviating from the words explicitly used in the passage in the choices. For example (The excerpt contains the word tribute):
Correct: “The passage describes how the Majapahit maintained power through naval patrols and collecting taxes from merchants.”
Incorrect: “The passage describes how the Majapahit maintained power through naval patrols and collecting tribute from merchants.”
</ANSWER_OPTION_RULES>
<LEARNING_CONTENT_RULES>
   The Learning Content should be a paragraph that is 80-100 words.
   The Learning Content should begin with “Here's what you need to know:”
   The tone of Leaming Content should be educational and accessible because high schoolers are the audience.
   The Learning Content cannot have parentheses.
   The Leaming Content should not use the words “stimulus” or “AP”
</LEARNING_CONTENT_RULES>

</RULES>
<CURRICULUM>
<UNITS>
{{courseDomains}}
</UNITS>
<CLUSTERS>
{{courseClusters}}
</CLUSTERS>
<OBJECTIVES>
ID - DESCRIPTION
{{courseL1ListWithIDs}}
</OBJECTIVES>
<KEY CONCEPTS>
ID - DESCRIPTION
{{courseL2ListWithIDs}}
</KEY CONCEPTS>
<Historical Developments>
ID - DESCRIPTION
{{courseL3ListWithIDs}}
</Historical Developments>
<Substandards>
ID - DESCRIPTION
{{courseL4ListWithIDs}}
</Substandards>
</CURRICULUM>
<SUBSTANDARD>
Substandard: {{I1StandardRandomL4StandardDescription}}
</SUBSTANDARD>

Remember to adhere closely to the curriculum content and ensure that your questions align with AP United States History standards. The provided Substandard MUST be used as the primary_standard_covered for at least one of your generated MCQs. The remaining questions should assess related substandards that create a cohesive set of questions around the same historical context.

The content generation system 118 receives input from the online learning platform 102 using the data collector 122, as the user interacts with the test-prep mode 106. This includes interactions of the user with the test prep mode 106, and scores obtained in the mock test 108 which allows the content generation system 120 to analyze the user mastery level and weak areas. The use of machine learning algorithms plays a crucial role in analyzing the user's performance data to identify weak areas and the topics where the user needs to improve. By extracting semantic and contextual information from the input the content generation system 118 ensures to analyze the user performance data 114 and mastery data 116.

The test-proportionate content planning module 120 also employs exam data 140 to identify the weightage of topics within the one or previous exam. These algorithms analyze the weightage of the content in the previous exams and map them to user input data to identify weak areas of the user where the mastery level is low but the exam weightage is high and adjusts its response accordingly by generating prompts based on the corresponding analysis.

The test planning module employs exam data 140 to interpret the user's response using natural language processing to generate and evaluate questions. These algorithms analyze the student learning data to generate questions targeting the weaker areas of the user and adjust its response accordingly by generating prompts based on corresponding analysis.

The prompt generator 128 utilizes the above data and populates the prompt structure using this data along with following the rules and guidelines shared by the prompt engineer to generate the prompt. The generated prompts are then transferred to guide the AI engine 130. The prompt generator 128 is operatively coupled to the AI engine 130 and populates prompt structure based on the inputs received from the content generation system 118. The prompt generator 128 transfers the prompts to guide the AI engine 130 in providing appropriate personalized content for accelerated exam preparation. By integrating the context of the test prep mode 106, user interactions with the online learning platform 102, and user performance data 114, the prompt generator 128 formulates precise and contextually relevant prompts.

The exemplary prompts transferred by the prompt generator 128 to the AI engine 130 is given below:
Context
You are a multiple-choice question (MCQ) generator that produces a very difficult question for students, to assess whether they have mastered the given Historical Development for AP US History. You will be given an ‘Historical Development’, ‘Cluster’, ‘Domain’, ‘Historical Thinking Skill’, an ‘Example’ delimited by ∥|, and ‘Key Concept List’ delimited by″″″.
Task
1. Using the Rules listed below, write a very challenging AP US History exam MCQ similar in structure and style to the ‘Example’, while focusing on the key term: “Ku Klux Klan” to directly assess student's knowledge of the ‘Historical Development’. The generated question must also assess student's ability to apply ‘Historical Thinking Skill’.
2. You may use the ‘Cluster’, ‘Domain’, and ‘Key Concept List’ for additional historical context.
3. Write 4 answer options (A, B, C, D) for the question. Ensure that only one option is true while the remaining options are false. Include short explanations for each answer choice, explaining why the answer choice is correct or incorrect.
4. Create one Learning Content that helps users learn everything they need to answer the question. The Learning Content should guide the student toward the right answer without directly giving away the correct answer choice. Also, the learning content should NOT use parentheses; any additional or relevant information typically inserted within parentheses should be coherently embedded into the sentence.
5. Rate the outputs on a scale of 1-10 for the following criteria:
   question_relevance: how relevant is the question to the historical development?
   question_difficulty: how difficult is the question?
   learning_content_quality: How effective is the learning content in guiding the student in the correct direction?
Output Template
Question: The generated MCQ Question
Options: A list of the four answer choices, along with an explanation and a correctness marker which marks the single correct answer as true
Learning Content: The learning content required to understand the question
Rating: The ratings for the generated question. All ratings MUST be an integer between 1 and 10
Rules
Word Count Rules:
Answer Explanation: 20 words or less
Learning Content: 80 to 100 words, 4-6 sentences
MCQ Generator Rules:
The MCQ generator must produce a very challenging MCQ that demands an in-depth understanding of the ‘Historical Development’, and contains plausible incorrect answer choices.
The MCQ generator places less emphasis on simple recall and more emphasis on evaluating student's understanding of the ‘Historical Development’ and the ability to apply the ‘Historical Thinking Skill’.
The MCQ generator must not directly reference the ‘Historical Development’, ‘Cluster’, ‘Domain’, and ‘Key Concept List’ in the question.
The MCQ generator should NOT use the specific words “course”, “historical development”, “cluster”, “standard”, “learning objective”, or “historical thinking skill” in the question, answer choices, learning content, or explanations.
The MCQ generator must generate four total answer choices (A, B, C, D) and ensure that ONLY one answer choice is correct.
The MCQ generator must ensure that all answer choices are consistent in length, using the same number of words, phrases, and clauses across all options.
Incorrect Answer Choices Rules:
All incorrect answer choices should be challenging to eliminate, and not use characteristics that are uniformly opposite to those of the correct answer. Incorrect answer choices should offer subtle variations, compelling the student to employ knowledge, understanding, and reasoning to distinguish between the correct and incorrect correct answer choices.
All incorrect answer choices should be plausible, realistic, and challenge common student misconceptions while maintaining a consistent narrative or theme as seen in the correct answer. High quality incorrect choices should help to test for a comprehensive understanding of the content.
All incorrect answer choices should be closely related to the question content, presenting plausible but incorrect alternatives based on common misconceptions or errors in reasoning.
All incorrect answer choices, while maintaining a consistent narrative or theme as seen in the correct answer, can contain some truths but should ultimately lead to a wrong conclusion if chosen.
Avoid the use of extreme language or absolute terms in incorrect answer choices, so the incorrect answer choices are NOT easier to eliminate.
Do NOT use phrases like “all of the above,” “none of the above,” and phrases that reflect absolute positions like “always,” “never,” “none,” “all,” and “universally” for the incorrect answer choices.
Learning Content Rules:
The Learning Content must always begin with “Here's what you need to know”.
The Learning content should NOT use parentheses. Any additional or relevant information typically inserted within parentheses should be coherently embedded into the sentence.
The Learning Content must provide educational value, summarize necessary information to solve the question, and support the student's understanding.
The Learning Content should NOT directly reveal the correct answer or reference incorrect answer choices as negative or incorrect examples. Its purpose is to help the user understand the educational concept and apply their knowledge.
The Learning Content must NOT use the exact wording used in the correct answer choice.
The Learning Content must NOT make any reference to the Historical Thinking Skill.
Core Input
Historical Development: Segregation, violence, Supreme Court decisions, and local political tactics progressively stripped away African American rights, but the 14th and 15th amendments eventually became the basis for court decisions upholding civil rights in the 20th century
Historical Thinking Skill: Explain how a historical development or process relates to another historical development or process.
Cluster: Failure of Reconstruction
Domain: Period 5:1844-1877
Key Concept List: ″″″Ku Klux Klan
Black codes
Racial vigilantism
Lynching
Jim Crow Laws
Southern resistance
tactics of white supremacist groups during Reconstruction
Civil Rights Cases of 1883
Slaughterhouse Cases (1873)
14th Amendment interpretations
15th Amendment limitations
Segregation cases
Civil liberties erosion
Supreme Court conservativism
Election of 1876
Compromise of 1877
Legalized racial discrimination
Plessy v. Ferguson (1896)
Brown v. Board of Education (1954)-ruling based on 14th Amendment would later end segregation
Freedmen's Bureau dismantling
White League activities
Redeemers
Election rules
Voting intimidation
Poll taxes
White supremacy
Gerrymandering
Mississippi Plan
End of Reconstruction″″″
Example: ∥| Question:
Which of the following best explains a connection between the economic productivity of the United States in the mid-1800s and in the late 1800s?
Option A:
Answer: The application of new technologies expanded large-scale industrial manufacturing.
Explanation: Correct. The application of new technologies allowed increasingly rapid and efficient manufacturing in the late nineteenth century. For example, standardized parts allowed more efficient assembly of products, and the introduction of the Bessemer furnace allowed the expansion of steel manufacturing.
Option B:
Answer: Labor unions sought to improve conditions in factories and wages for workers.
Explanation: Incorrect. Although workers did often organize labor unions in the late nineteenth century in efforts to improve wages and working conditions in factories, business productivity increased nonetheless, and the efforts of labor unions did not hamper this expansion.
Option C:
Answer: The use of sharecropping in the South expanded cotton agricultural production.
Explanation: Incorrect. Although the introduction of sharecropping in the South after the Civil War did allow cotton production to return to profitable levels, sharecropping was not used prior to the Civil War and it was confined to relatively narrow areas of agriculture.
Option D:
Answer: Corporations' need for managers fostered the growth of a large middle class.
Explanation: Incorrect. Although the growth of business organizations did foster the emergence of a large, distinctive middle class in the late nineteenth century, this more likely was a result of increased business productivity rather than a cause of it. In addition, the development of modern corporations only began to occur after the Civil War and not in the mid-nineteenth century.

In operation 212, the prompt generator 128 transfers the generated prompts to the AI engine 130 to generate personalized content for the user on a real-time basis.

The generated prompts are then transferred to the AI engine 130 which processes them to generate a detailed personalized response. The response aims to generate personalized content for the user to explain the educational concepts that are important from an exam standpoint ensuring a comprehensive learning of the user.

The AI engine 130 generates content whenever a user is facing any difficulty in the learning and understanding the concepts of educational content, provides incorrect answers, and so on. The AI engine 130 generates personalized content using an advanced machine learning algorithm. The response is presented to the user in the form of a generated test 136, generated personalized content 138, and real-time tutor 110 to ensure effective communication and accelerate the learning.

The codes and functions mentioned in the pseudo-code of the personalized content generation system 100 for accelerated exam preparation based on the mastery level of the user on various educational standards and the weightage of the educational standards to guide the user using the real-time tutor 110 are explained below in correspondence to the above-mentioned details.

The function ‘ai_tutor_support (question_id, student_response)’ provides assistance when a student answers a question incorrectly during a practice test. It checks the correctness of the student's response using ‘question_id’ and ‘student_response’. If incorrect, it fetches a video explanation for the question and opens a chat interface for further assistance, offering a deeper understanding and immediate feedback.

The AI engine 130, guided by prompt generator 128, interprets the user performance data 114 and mastery data 116 to generate personalized content for the user. The AI engine 130 includes modules such as test preparation module 132 and personalized content generation module 134.

The AI engine 130 first uses the test preparation module 132 to prepare a customized mock test 108 for the user based on the user performance data 114 and mastery data 116. The test preparation module 132 utilizes the AI engine 130 to generate multiple-choice questions that assess the user's mastery over specific standards. For instance, Emma is preparing for the AP chemistry exam. The AI engine 130, utilizes test preparation module 132 to generate a customized test focusing on her weak areas such as organic chemistry. As she completes the test, she receives feedback highlighting specific concepts she needs to review. The question bank 142 provides the questions to the AI engine 130 to generate appropriate content. In one of the embodiments, the questions can be in the form of MCQ, fill-in-the-blanks, true/false, and so on.

The test preparation module 132 provides inputs to personalized content generation module 134, integrated within the AI engine 130. The personalized content generation module 134 generates personalized content 138 based on received inputs. The personalized content generation module 134 compiles personalized content from questions bank 144 including learning materials and activities targeting the identified weak topics.

The codes and functions mentioned in the pseudo-code of the personalized content generation system 100 for accelerated exam preparation based on the mastery level of the user on various educational standards and the weightage of the educational standards to generate the mock test 108 are explained below in correspondence to the above-mentioned details.

The function ‘generate_custom_ap_test(standards_coverage, student_performance)’ creates personalized AP test simulations focusing on the user's weaker areas. It uses ‘standards_coverage’, a dictionary indicating the coverage of each standard in the test, and ‘student performance’, another dictionary that tracks the user's performance by standard. If a user's performance on a particular standard falls below a predefined threshold (THRESHOLD), the function fetches relevant questions for that standard, assembling them into a custom test to target and improve these weaknesses.

In operation 214, the generated personalized content 138 is shared with the user using the user interface 104. The generated personalized content 138 includes content related to the topics where the mastery level of the user is low, but the weightage of the topic to come in the exam is high.

The AI engine 130 generates personalized content 138 for the user which is presented to the user on an online learning platform. The generated test 136 includes a list of questions to prepare a mock test 108 which are important from the exam standpoint and specifically targeting the educational concepts with low mastery level. The user then attempts the mock test 108 in the test prep module 106 to strengthen the weaker educational concepts. This comprehensive process helps the user to prepare for the exam in a short time period aiming to get higher scores in the exams.

The generated personalized content 138 is displayed to the user interface 104 after the user completes the mock test 108. The generated personalized content 138 includes a playlist of targeted areas focusing on the user's areas of improvement while giving a mock test 108. The playlist is generated using a playlist generator 146. The playlist includes a list of videos that include content from the user's weaker areas. For instance, Sara is preparing for the AP physics exam. After taking the mock test 108, the content generation system 118 identifies electromagnetism as her weak area. The playlist generator will compile a list of videos, readings, and quizzes on electromagnetism for her to study.

The playlist includes a short content which allows the user to learn through the content. The content can be in the form of a video which includes MCQs, fill-ups, and memes to enhance the learning. As the user attains mastery in the particular concept the user can again take the mock test 108 to enhance the learning. The real-time tutor 110 also appears on answering the question incorrectly to increase the understanding of the concept. The playlist generator 146 develops a playlist prioritizing the topics within the generated content based on the level of mastery of the weak topics and their weightage in the exams.

The codes and functions mentioned in the pseudo-code of the personalized content generation system 100 for accelerated exam preparation based on the mastery level of the user on various educational standards and the weightage of the educational standards to generate the playlist are explained below in correspondence to the above-mentioned details.

The function ‘generate_learning_playlist(test_results)’ generates a learning playlist based on a user's test results. It takes ‘test_results’, a dictionary containing scores for each standard, and sorts these scores in ascending order. The function identifies standards where the student's performance is below the threshold (THRESHOLD) and fetches corresponding study materials, thus creating a playlist that focuses on improving the weakest areas first, optimizing the user's learning efficiency.

Below is the pseudo-code for a personalized content generation system 100 for accelerated exam preparation based on the mastery level of the user on various educational standards and the weightage of the educational standards:

```
# Function to align content distribution based on exam standards
def distribute_content_based_on_exam_proportions(exam_standards, study_material):
  ″″″
  Distributes study material to the student based on the proportional representation
  of standards on an exam.
  :param exam_standards: A dictionary with standards and their proportional weight on
the exam
  :param study_material: A list of study materials tagged with standards
  :return: A list of study materials ordered by their importance for the exam
  ″″″
  # Initialize an empty list for ordered study materials
  ordered_study_materials = [ ]
  # Iterate over each standard in the exam standards
  for standard, weight in exam_standards.items( ):
    # Filter study materials that include the current standard
    relevant_materials = [material for material in study_material if standard in
material[‘standards']]
    # Sort the relevant materials by their alignment with the standard's weight
    sorted_materials = sorted(relevant_materials, key=lambda x: x[‘alignment_score’],
reverse=True)
    # Add the sorted materials to the ordered study materials list
    ordered_study_materials.extend(sorted_materials)
  # Return the ordered list of study materials
  return ordered_study_materials
# Pseudo-code for AI-Generated Custom AP Test Simulation
# Function to generate custom AP test simulations
def generate_custom_ap_test(standards_coverage, student_performance):
  ″″″
  Generates a custom AP test simulation based on the student's mastery over specific
standards/topics/units.
  :param standards_coverage: A dictionary with standards and their coverage in the test
  :param student_performance: A dictionary with student's performance on each
standard
  :return: A custom AP test simulation with questions targeting the student's weak areas
  ″″″
  # Initialize an empty list for the custom test questions
  custom_test_questions = [ ]
  # Iterate over each standard and its coverage
  for standard, coverage in standards_coverage.items( ):
    # Check the student's performance on the current standard
    performance = student_performance.get(standard, 0)
    # If the performance is below a certain threshold, add questions to the custom test
    if performance < THRESHOLD:
      questions = fetch_questions_for_standard(standard, coverage)
      custom_test_questions.extend(questions)
  # Return the custom test simulation
  return custom_test_questions
# Pseudo-code for AI tutor support during practice tests
# Function to provide AI tutor support
def ai_tutor_support(question_id, student_response):
  ″″″
  Provides AI tutor support when a student gets a question wrong on a practice test.
  :param question_id: The ID of the question the student answered
  :param student_response: The student's response to the question
  :return: A video explanation and a chat interface for further support
  ″″″
  # Check if the student's response is incorrect
  if not is_correct_response(question_id, student_response):
    # Fetch the relevant video explanation
    video_explanation =fetch_video_explanation(question_id)
    # Open a chat interface for further questions
    chat_interface = open_chat_interface(question_id)
    # Return the video explanation and chat interface
    return video_explanation, chat_interface
# Pseudo-code for Efficiency-Oriented Learning Playlist Generator
# Function to create a learning playlist
def generate_learning_playlist(test_results):
  ″″″
  Creates a customized learning playlist based on test results, focusing on the user's
weakest areas.
  :param test_results: A dictionary with test results for each standard
  :return: A learning playlist targeting the weakest areas
  ″″″
  # Initialize an empty list for the learning playlist
  learning_playlist = [ ]
  # Sort the test results by the score, ascending
  sorted_results = sorted(test_results.items( ), key=lambda x: x[1])
  # Iterate over the sorted results and add materials to the playlist
  for standard, score in sorted_results:
    if score < THRESHOLD:
      materials = fetch_study_materials_for_standard(standard)
      learning_playlist.extend(materials)
  # Return the learning playlist
  return learning_playlist
```

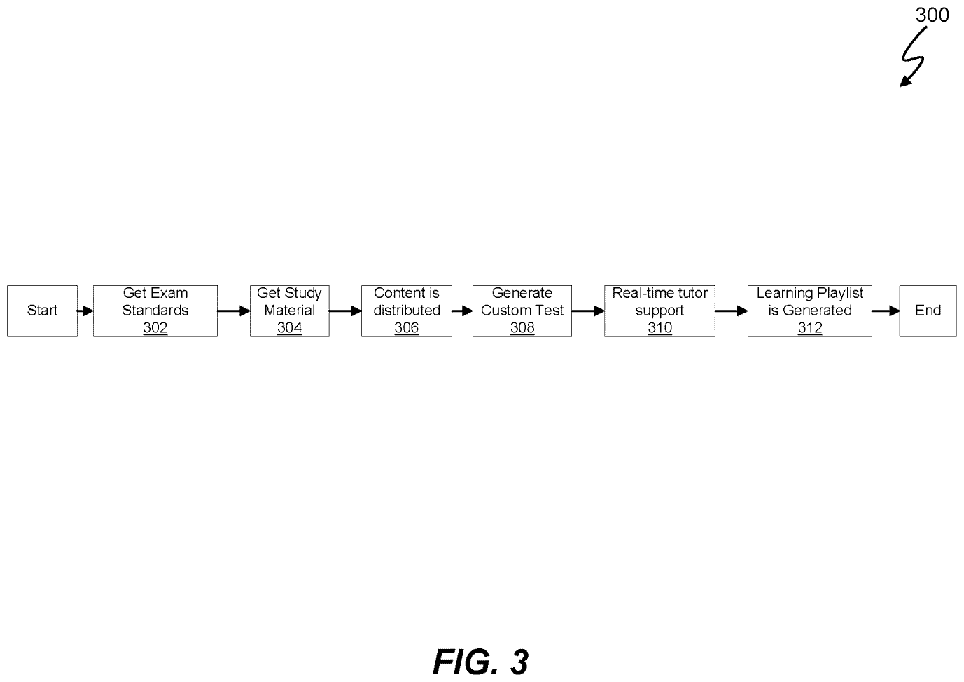

FIG. 3 depicts a flowchart 300 showing the steps of generating personalized content 138 to accelerate the preparation of users for an exam.

The flowchart 300 depicts the steps involved in the generation of the playlist. Initially, the exam standards are fetched 302 using the data collector 122 which is important for a particular exam. Once the exam standards are identified, study material 304 relevant to the exam standards is fetched, where the study material includes the list of questions and other learning content. The content is then distributed based on its relevance to particular standards and topics. As the content is distributed 306 by the content generation system 118, the test preparation module 132 of the AI engine 130 generates mock test 308. The mock test 308 is personalized based on the user mastery level and areas where the user lags but has a higher weightage in the exams. As the user interacts with the mock test and answers a question incorrectly, a real-time tutor support 310 is provided. The real-time tutor 110 helps the user to enhance the understanding of that educational concept.

In one of the embodiments, the user may also provide feedback after finishing the test. The feedback can be in the form of a text, or voice note. Natural language processing techniques are used to analyze text-based feedback and generate insights to enable the integration of user feedback into iterative updates and enhancements of educational content, learning materials, and platform features to enhance user experience and learning outcomes.

As the user completes the test and provides the feedback, a learning playlist is generated 312 using the playlist generator 146. The learning playlist includes short content and can be used to enhance the learning at a fast pace. The learning playlist is generated including study material related to topics where the user has a low mastery level but the topics have a high weightage to come in the exam.

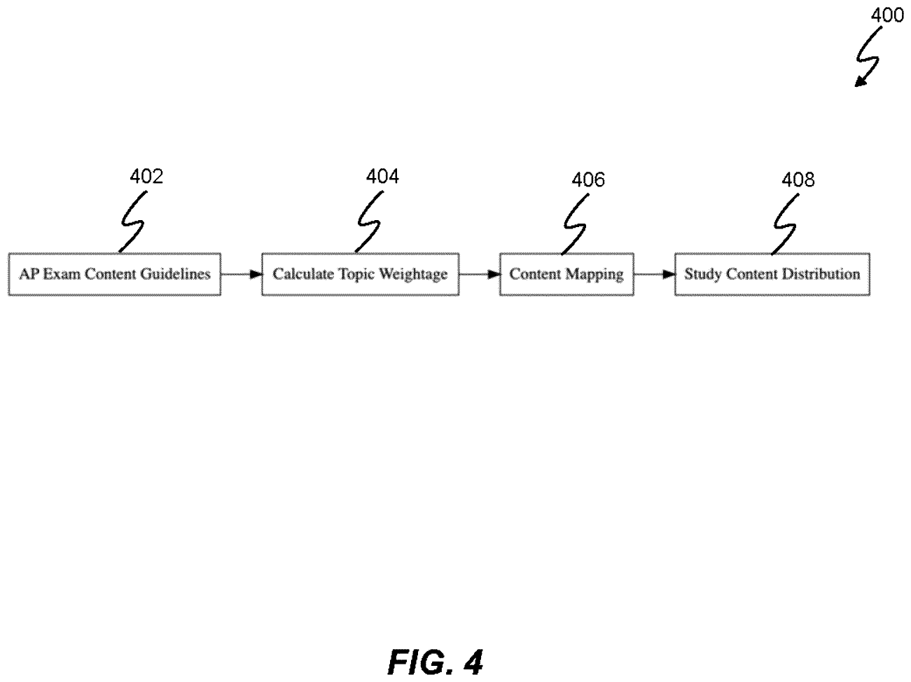

FIG. 4 depicts an exemplary educational content distribution process 400, which is an embodiment of the personalized content generation process 200 in FIG. 2.

The educational content distribution process 400 represents the steps involved in generating study content for the mock test 108, where the content is personalized as per the mastery level of the student on standards important from an exam standpoint. Initially, the educational content distribution process 400 starts with fetching AP exam content guidelines 402 from the exam data 140 which includes all the topics and standards important from the exam standpoint using a data collector 122. The weightage calculation module 126 within the test-proportionate content planning module 120 calculates the weightage of the topics and standards from the exam data 140.

As the user attempts the mock test 108 and marks the questions correct and incorrect. The user response is stored within the memory 112 of the online learning platform 102. Based on the user performance data 114, the mapping module 124 within the test-proportionate content planning module 120 leads to content mapping. The questions that were marked incorrect by the user are mapped against their weightage in the exam. The content generation system 118 then sends study content distribution on the online learning platform 102 with the help of the mapping module 124 to distribute the content which will effectively improve student performance. The prompt generator 128 populates the prompt structure provided to it by the prompt engineer. The prompt structure along with the rules and guidelines are provided to the prompt generator 128 which is then populated by the prompt generator 128 using the data fetched by the data collector 122.

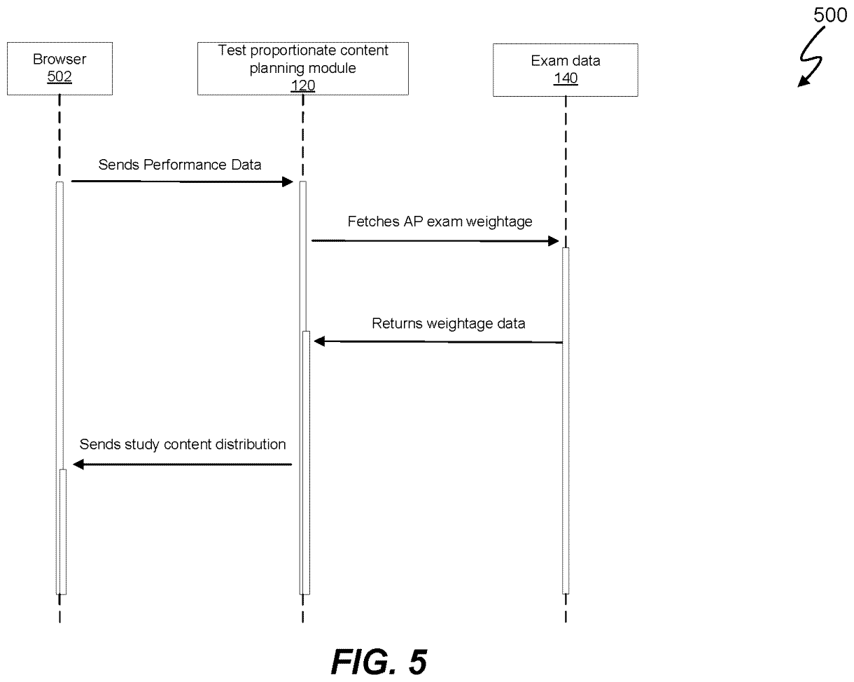

FIG. 5 depicts a curriculum weightage-based content distribution process 500, which is an embodiment of the personalized content generation process 200 in FIG. 2.

The curriculum weightage-based content distribution process 500 illustrates the interaction between a browser 502, the test-proportionate test planning module 120, and the exam data 140 to create a personalized study plan. The curriculum weightage-based content distribution process 500 begins with the browser 502, which serves as the user interface 104 on a student's device, sending detailed performance data to the data collector 120 (not shown in the figure) of the test-proportionate test planning module 120. This data includes various metrics such as the student's scores, strengths, weaknesses, and study habits.

The test-proportionate test planning module 120, upon receiving this data, needs additional context to generate the study materials, therefore, it requests the AP exam weightage data from the exam data 140, which contains information on the proportional importance of different subjects and topics on the AP exam. The exam data 140 provides this weightage data back to the weightage calculation module 126 (not shown in the figure) of the test-proportionate test planning module 120. This weightage information helps in understanding which subjects are most critical for the exam, allowing it to prioritize study materials accordingly. The test-proportionate test planning module 120 then processes the combined performance data and exam weightage information to generate a customized distribution of study content. Finally, the educational content is sent back to the browser 502, providing the student with a study plan that emphasizes key areas for exam preparation.

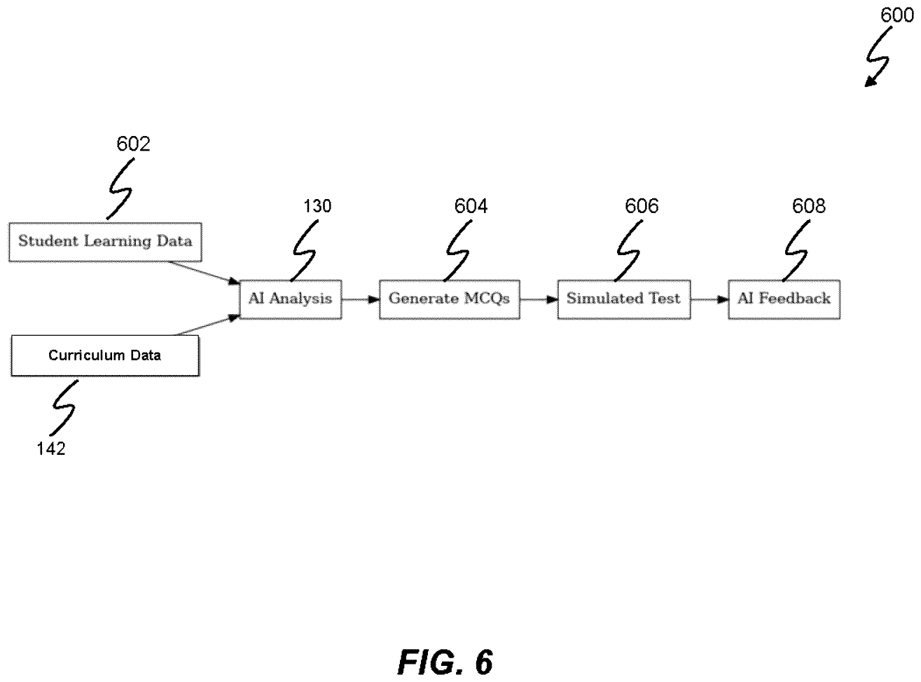

FIG. 6 depicts a feedback providing process 600 to the user based on the generated mock test 108, which is an embodiment of the personalized content generation process 200 in FIG. 2.

The feedback providing process 600 illustrates student learning through personalized educational content. The feedback providing process 600 begins with two main inputs: student learning data 602 and curriculum data 142. The student learning data 602 incorporates various metrics such as performance on past assessments, strengths, weaknesses, and overall progress. This data is crucial for understanding each student's unique learning needs. Simultaneously, the curriculum data 142 defines the required knowledge and skills that students must acquire according to educational guidelines.

Both data sets are fetched by the data collector 122 (not shown in the figure) and passed on to the AI engine 130 after mapping using the mapping module 124 according to the curriculum weightage. This analysis identifies gaps in the student's knowledge by comparing their current understanding against the curriculum standards. Based on this analysis, the MCQs are generated 604 where it creates multiple-choice questions (MCQs) to address the identified gaps and support the required knowledge.

These generated MCQs 604 are then used in the simulated test phase 606, where students can attempt the questions in a controlled, test-like environment in the online learning platform 102. Following the simulated test 606, the results are fed into the feedback stage 608. In this final stage, the AI engine 130 provides detailed feedback on the student's performance, highlighting areas of improvement and suggesting further study materials or practice questions. This feedback loop helps students focus their study efforts on areas where they need the most improvement, thereby optimizing their learning experience.

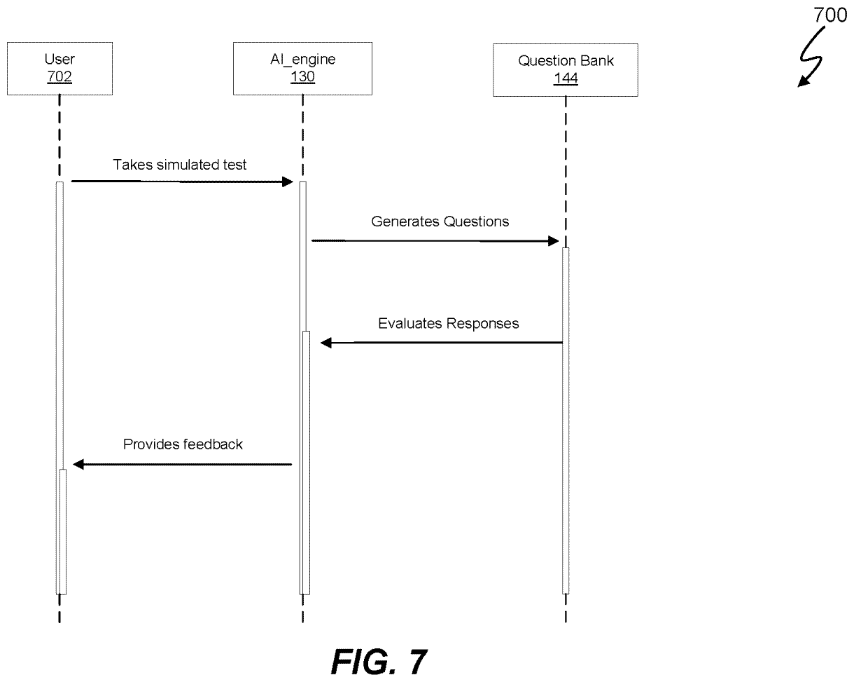

FIG. 7 depicts a mock test generation process 700, which is an embodiment of the personalized content generation process 200 in FIG. 2.

The mock test generation process 700 illustrates the interaction flow between a user, an AI engine 130, and a question bank 144 during a simulated test process. The mock test generation process 700 begins with the user taking a mock test 108. This action involves the user interacting with the user interface 104 of the online learning platform 102 to start the mock test 108, which includes a series of questions aimed at assessing their knowledge and understanding of specific topics.

Next, the AI engine 130 responds to the user's action by generating the questions for the simulated test. This step involves the AI engine 130 accessing question bank 144 to select or create appropriate questions based on predefined criteria, such as the user's level, the subject matter, or the focus areas intended for assessment using test preparation module 132. The AI engine 130 ensures that the questions are relevant and appropriately challenging.

Once the user completes the mock test 108, the AI engine 130 evaluates the responses. The answers are sent back to the question bank 144, where they are analyzed against the correct answers or evaluation criteria. This evaluation process helps determine the user's performance, identifying areas of strength and weakness.

After evaluating the responses, the AI engine 130 compiles the results and provides detailed feedback to the user. This feedback includes an assessment of the user's performance, highlighting correct and incorrect answers, and may also offer explanations, tips for improvement, or suggestions for further study. The feedback is crucial for the user's learning, as it helps them understand their mistakes and areas that require additional focus.

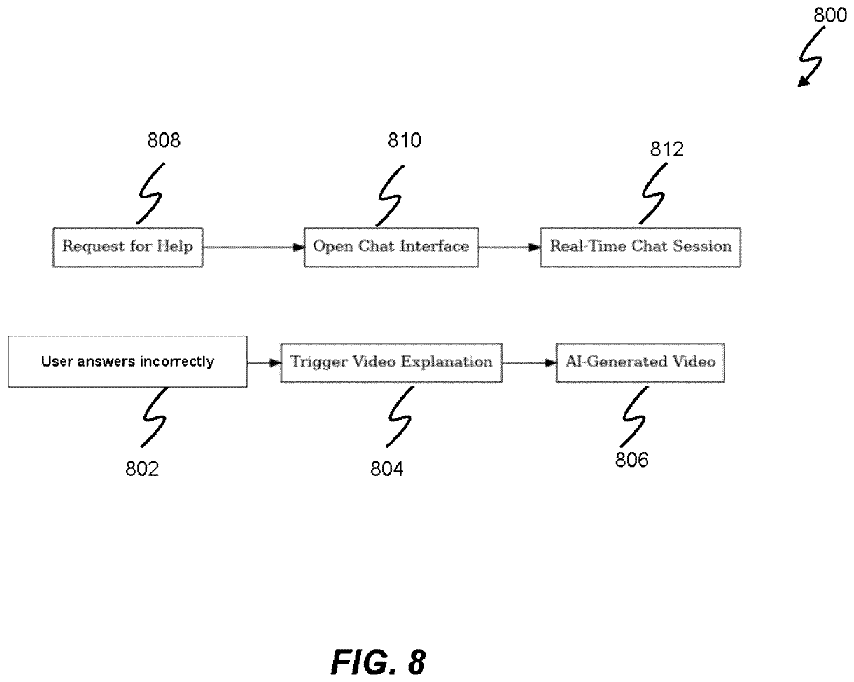

FIG. 8 depicts a real-time assistance providing process 800 to the user during a mock test 108, which is an embodiment of the personalized content generation process 200 in FIG. 2.

The user accesses the test prep mode 106 on the online learning platform 102 and submits the user's responses to various questions included in the mock test 108. Each incorrect answer triggers a video explanation 804. The real-time assistance providing process 800 utilizes technologies such as GenAI to animate a historical figure that teaches the concepts via an AI-generated video 806. The real-time tutor 110 assists the user. The real-time tutor 110 helps in understanding the failed concept.

The real-time tutor 110 explains the concept using a video of a historical figure. The user can watch the video and if the user is facing difficulty in understanding the concept explained by the real-time tutor 110 then he/she can request for help 808. The user opens a chat interface 810 which allows him/her to interact with the real-time tutor 110. The user writes the query in the chatbot, further to which the real-time tutor 110 responds. This real-time chat session 812 allows one-on-one tutoring sessions which is both engaging and responsive to student's needs.

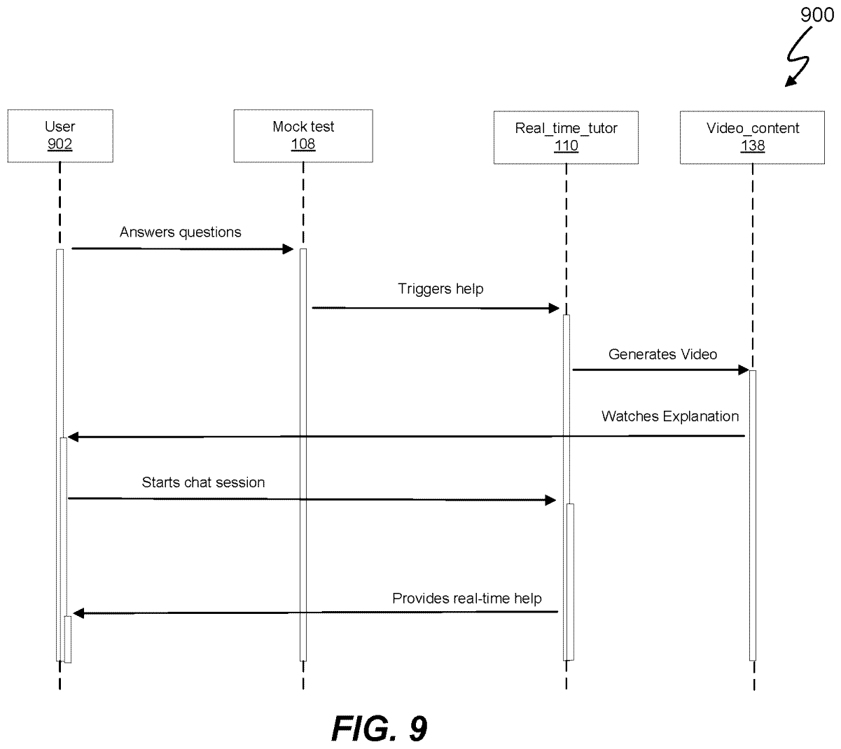

FIG. 9 depicts an interaction process 900 between the user and the real-time tutor 110 for seeking guidance, which is an embodiment of the personalized content generation process 200 in FIG. 2.

The interaction process 900 between the user and the real-time tutor 110 for seeking guidance outlines an interactive educational session involving a user 902, the online learning platform 102, the Real-time tutor 110, and video content 138. The interaction process 900 between the user and the real-time tutor 110 for seeking guidance begins with the user 902 engaging with the online learning platform 102 by answering a question of the mock test 108. This initial interaction represents the user's 902 attempts to assess their understanding of a particular topic or concept.

If the user 902 struggles with the question or requires additional assistance, the online learning platform 102 automatically triggers help from the Real-time tutor 110. This mechanism ensures that the user 902 receives timely support, preventing frustration and aiding in the learning enhancement. Upon activation, the Real-time tutor 110 assesses the user's 902 response and the specific learning need, then generates the video explanation 138 using personalized content module 134. This video content is designed to address the exact area of confusion, providing a clear and concise explanation to help the user 902 understand the concept.

The user 902 then watches the video explanation, gaining valuable insights and clarifying any misunderstandings. This step allows the user 902 to learn at their own pace, revisiting the content 138 as needed to fully grasp the material. After watching the video, if the user 902 still has questions or needs further clarification, they can start a chat session with the Real-time tutor 110. This feature provides an opportunity for more personalized interaction, where the user 902 can ask specific questions and receive tailored responses.

The Real-time tutor 110 then provides real-time help, engaging in a dynamic and interactive session with the user 902. This real-time assistance is crucial for addressing any remaining doubts, offering additional explanations, or guiding the user 902 through complex problems. The combination of automated video content and live chat support ensures a comprehensive learning experience, accommodating different learning styles and needs.

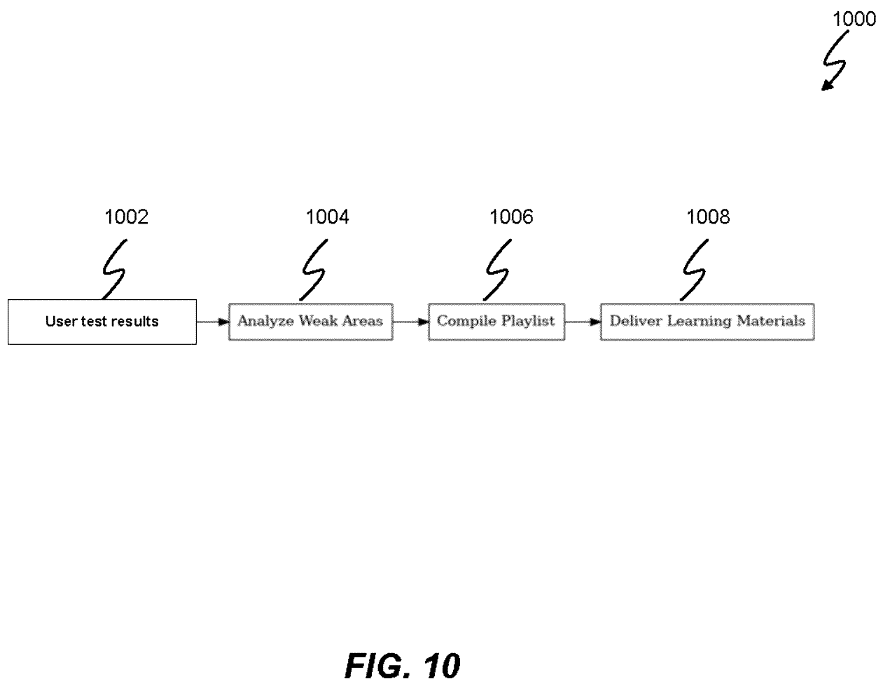

FIG. 10 depicts an educational content delivery process 1000 based on the weaker areas of the user, which is an embodiment of the personalized content generation process 200 in FIG. 2.

Initially, the data collector 122 114 within the content generation system 118 analyzes the user test results 1002. The response is saved within the memory 112 of the online learning platform 102. The user test module 114 analyzes weak areas 1004 in which the user lags. The personalized content generation module 134 compiles playlist 1006 based on the user's weaker areas and the proportionate content having the higher weightage.

The personalized content is then displayed on the user interface 104. The personalized content includes videos and questions on the relevant concepts to deliver learning material 1008 to the user to enhance the learning for effective preparation for the exam.

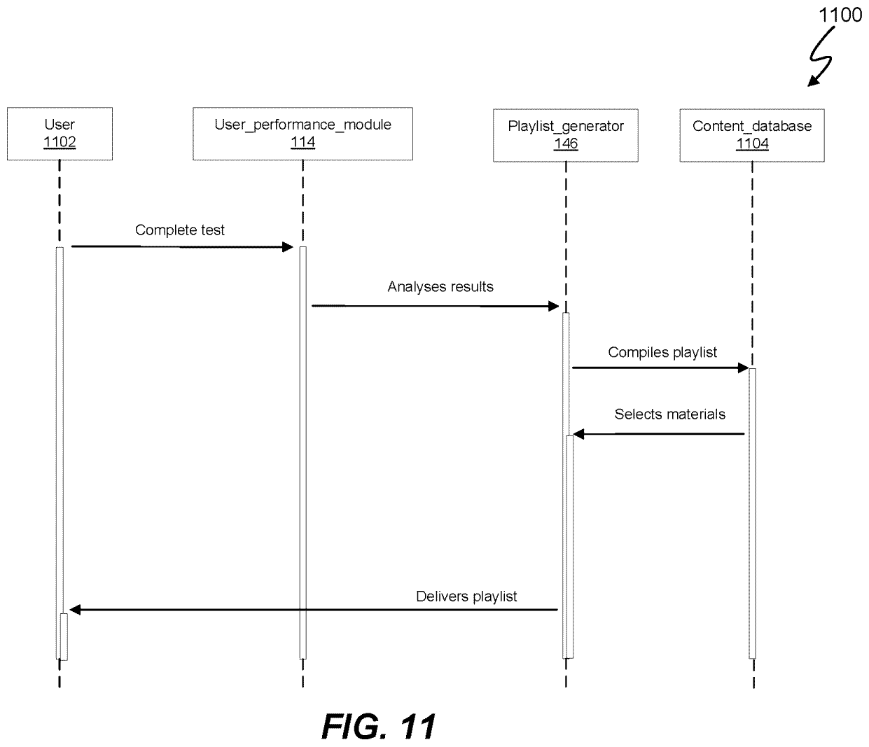

FIG. 11 depicts a mock test 108 analysis process 1100, which is an embodiment of the personalized content generation process 200 in FIG. 2.

The user logs onto an online learning platform 102 and gives the mock test 108 presented in the test-prep mode 106. As the user completes the mock test 108 the data collector 122 analyzes the results of the mock test 108. The user's performance depends on the number of questions the user gets right. The results are then fetched onto the playlist generator 146 wherein the playlist generator 146 uses the data which needs to be compiled using a content database 1104. The playlist is created based on the user's weaker areas and the proportion of content with higher weightage in the exam which is calculated using the weightage calculation module 126. The playlist is then displayed to the user on the user interface 104 of the online learning platform 102 where the user interacts with the playlist to attain mastery and enhance the learning.

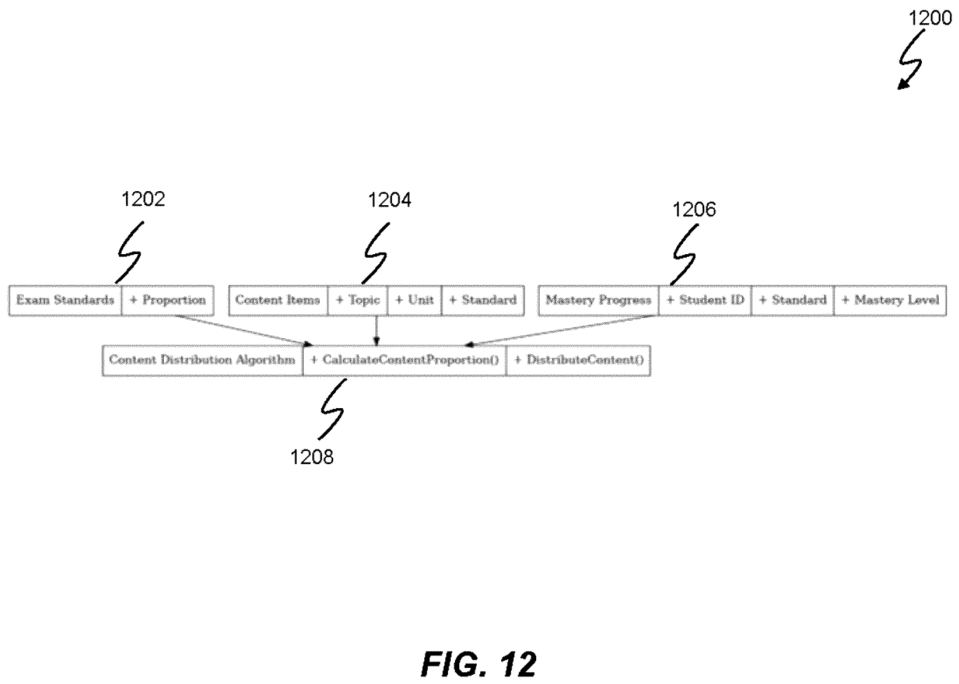

FIG. 12 depicts a data structure 1200 for organizing data that is used to distribute the educational content based on the curriculum data 142.

The data structure 1200 includes a plurality of components which include exam standards 1202, content items 1204, mastery progress 1206, and content distribution algorithm 1208 to distribute content to the user.

The data structure 1200 is designed to store educational content based on various inputs and criteria.

The first node, ExamStandards 1202, contains information about the exam standards, which includes details on the proportion of different topics or units that should be covered according to these standards. The ExamStandards node 1202 provides the foundational guidelines that dictate the focus areas for content distribution, ensuring that the content aligns with the critical areas assessed in exams. Next, the ContentItems node 1204 comprises details about the educational content available. The ContentItems node 1204 is structured with fields for each content item, including the specific topic, unit, and the corresponding standard it addresses. This categorization ensures that the content can be effectively matched to the required learning objectives and standards, making it easier to align with the curriculum and exam standards. The content from both nodes is fetched by the data collector 122 (not shown in the figure).

The MasteryProgress node 1206 contains data on individual user's mastery levels. The MasteryProgress node 1206 includes fields such as Student ID, Standard, and Mastery Level, which record each user's progress and understanding about specific standards. This data is crucial for personalizing content delivery, as it allows for identifying areas where users may need more focused instruction or additional resources.

The ContentDistributionAlgorithm node 1208 acts as the core processing unit in this data structure 1200. The ContentDistributionAlgorithm node 1208 includes functions like CalculateContentProportion( ) and DistributeContent( ) The CalculateContentProportion( ) function analyzes the data from the ExamStandards and ContentItems nodes to determine the appropriate proportion of content to be distributed for each topic or unit using the weightage calculation module 126 (not shown in the figure). The DistributeContent( ) function then uses this calculated proportion, along with the MasteryProgress data, to distribute content in correspondence to individual user's needs. The content distributed to the user is generated by the AI engine 130. This ensures that the educational content provided to each student is both relevant and proportionate to their current mastery level and the curriculum requirements.

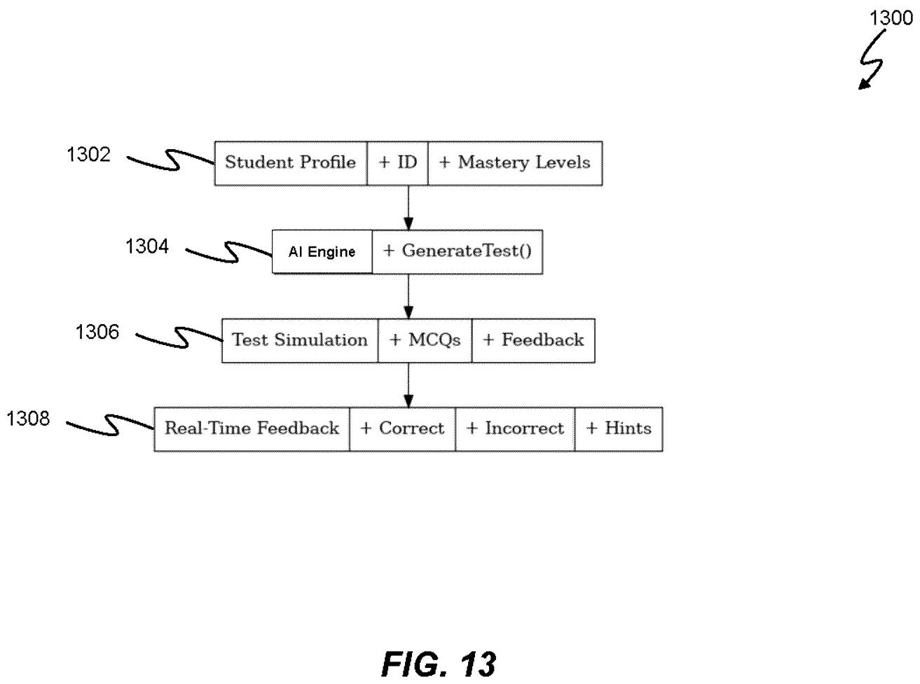

FIG. 13 depicts a data structure 1300 for organizing data that is used to simulate the AI-generated mock tests 108.

The data structure 1300 is used to provide data to design personalized test simulations and provide real-time feedback to users. The AIEngine node 1304 serves as the heart of the data structure 1300, equipped with the GenerateTest( ) function. This function is responsible for creating mock test simulations based on various inputs, particularly the data from the StudentProfile node 1302. The AI engine 130 uses sophisticated algorithms to generate questions in correspondence to the individual user's knowledge level and learning needs.

The StudentProfile node 1302 stores detailed information about each user, including unique identifiers (ID) and their mastery levels across different subjects or topics. This data is crucial for the AI engine 130 to accurately generate test simulations that are appropriately challenging and relevant to the user's current understanding. By utilizing this personalized data, the AI engine 130 can ensure that the generated tests are aligned with the user's learning journey, focusing on areas that need improvement.

Once the AI engine 130 generates the test using test preparation module 132, the personalized content 138 is passed to the TestSimulation node 1306 which represents the environment where the test simulation occurs, including multiple-choice questions (MCQs) and the collection of responses. The TestSimulation node 1306 serves as the interactive interface through which users engage with the test content.

The results from the TestSimulation node 1306 are then fed into the RealTimeFeedback node 1308 Which provides immediate feedback to users, detailing the correctness of their answers. The RealTimeFeedback node 1308 includes fields for Correct, Incorrect, and Hints, offering students not only an evaluation of their responses but also additional hints or explanations. This real-time feedback is critical for reinforcing learning, helping users understand their mistakes, and guiding them toward the correct answers.

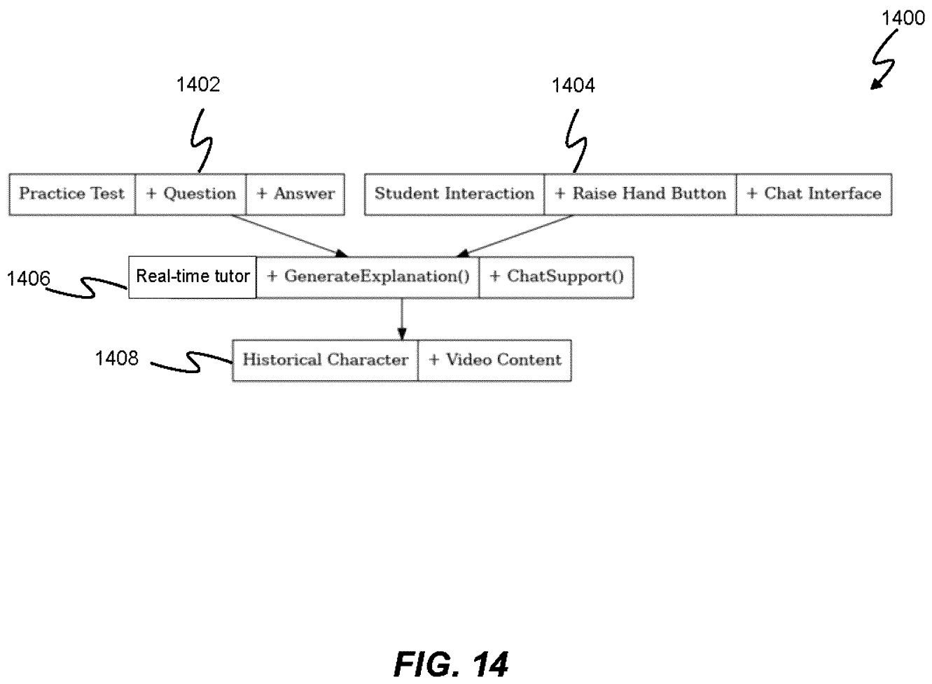

FIG. 14 shows a data structure 1400 for organizing data that is used to provide real-time assistance from real-time tutor 110 during the mock test 108.

The data structure 1400 is designed to provide data to enhance the learning experience through an AI-generated real-time tutor 110. The data structure 1400 integrates various components to provide interactive and supportive educational content to users.

The Practice Test node 1402 represents a repository of practice questions and answers. The questions in this node serve as the foundation for subsequent interactions and content generation within the system. The Real-TimeTutor node 1404 acts as the central part of the data structure 1400 equipped with advanced capabilities such as generating explanations and providing chat support. When a user engages with a mock test 108, the real-time tutor 110 analyzes their responses and can generate detailed explanations to help clarify concepts. Additionally, the Real-TimeTutor node 1404 offers chat support, allowing users to ask questions or seek further assistance on topics they find challenging. This feature enhances the learning by providing immediate, personalized guidance.

The UserInteraction node 1406 facilitates direct engagement between users and the real-time tutor 110. It includes interactive elements like the Interactive Button 148 (Raise Hand Button) and the user interface 104. The Raise Hand Button allows users to signal when they need help, prompting the real-time tutor 112 to offer assistance or explanations. The user interface 104 in the online learning platform 102 allows users to communicate with the real-time tutor 110, ask questions, and receive real-time feedback.

The HistoricalCharacter node 1408 adds an engaging, educational dimension by offering video content 138 related to historical characters or events. The real-time tutor 110 directs users to this content when relevant, providing a rich, multimedia learning experience.

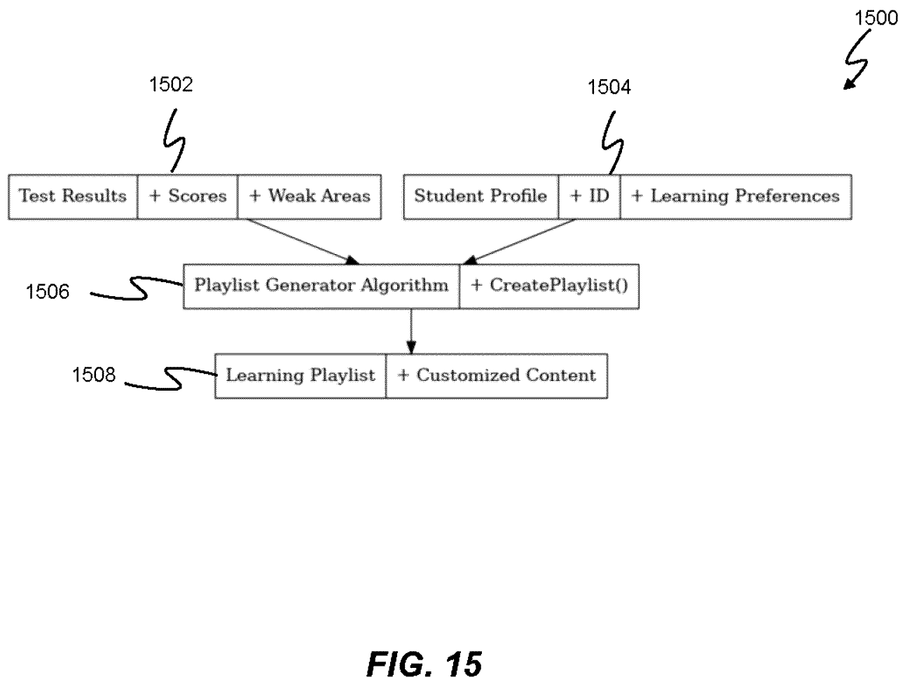

FIG. 15 depicts a data structure 1500 for organizing data to generate a personalized educational content playlist.

The data structure 1500 is designed to create personalized learning playlists for users based on their test results and individual learning preferences using the playlist generator 146 (not shown in the figure), thereby ensuring that users receive targeted educational content that addresses their specific needs and goals.

The TestResults node 1502 captures detailed data from user assessments, including scores and identified weak areas. This information is essential for understanding each user's current level of knowledge and pointing to the topics or skills that require further development. By analyzing these test results, the mapping module 124 can prioritize the areas where a user needs the most improvement. The UserProfile node 1504 stores comprehensive information about each user, such as unique identifiers and learning preferences. Learning preferences may include preferred learning styles (e.g., visual, auditory, kinesthetic), content formats (videos, articles, quizzes), and other personal preferences.

At the heart of the data structure 1500 is the PlaylistGeneratorAlgorithm node 1506 which uses the information from both the TestResults 1502 and UserProfile 1504 nodes to create a customized learning playlist using the playlist generator 146 integrated within the AI engine 130. The algorithm analyzes the test data to identify critical areas for improvement and considers the user's learning preferences to select the most appropriate content. This ensures that the generated playlist is not only relevant to the user's academic needs but also aligned with their preferred way of learning.

The output of the PlaylistGeneratorAlgorithm is represented by the LearningPlaylist node 1508 which contains a list of educational materials, such as videos, readings, interactive exercises, and quizzes, designed to help the user address their weak areas and enhance their understanding of specific topics.

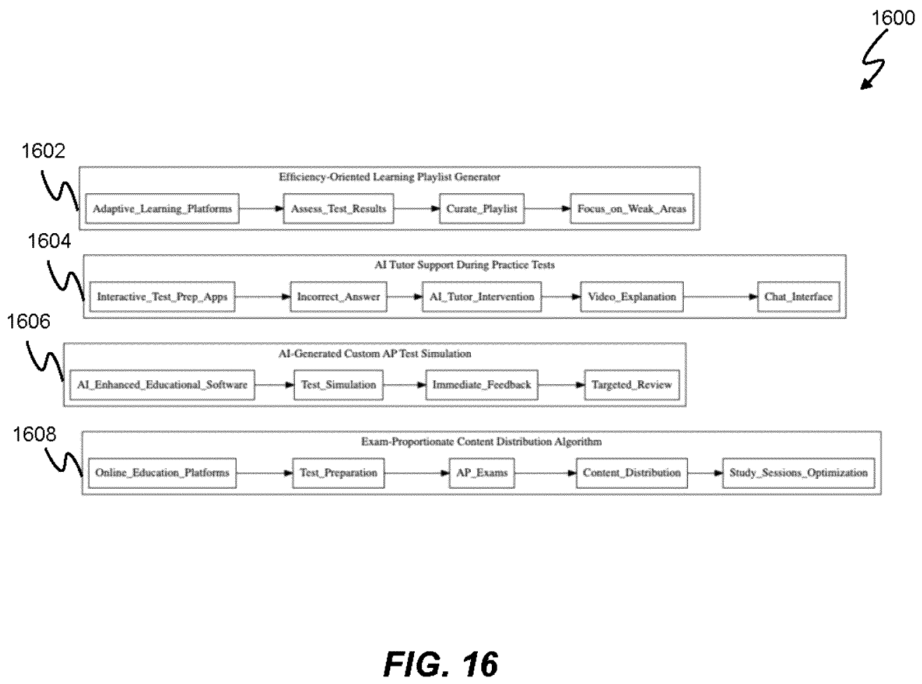

FIG. 16 depicts an educational content generation and real-time assistance providing process 1600 to the user giving the mock test 108, which is an embodiment of the personalized content generation process 200 in FIG. 2.

The Efficiency-Oriented Learning Playlist Generator 1602 can be used in online learning platforms 102. The Efficiency-Oriented Learning Playlist Generator provides an algorithm that curates a playlist of educational content targeting the student's weakest areas. In one of the embodiments, this educational content generation and real-time assistance providing process 1600 can be used in any educational setting that benefits from personalized learning paths, such as language learning apps or professional skill development courses.

The real-time tutorI tutor support during practice test 1604 can be used in interactive test preparation applications. When a student answers incorrectly, the real-time tutor, personified by a historical figure, intervenes with a video explanation and a chat interface allows for further questions, enabling a deeper understanding of the subject matter. In one of the embodiments, this educational content generation and real-time assistance providing process 1600 may provide support while learning in continuous education programs or corporate training modules.

The AI-generated Custom AP test simulation 1606 can be used in AI-enhanced educational software to simulate AP exam conditions. The AP test simulation provides immediate feedback on student performance, allowing for targeted review and improvement in specific areas. In one of the embodiments, AI-generated Custom AP test simulation can be extended to simulate other academic or professional exams, offering a personalized testing experience that adapts to the user's learning progress.

The Exam Proportionate Content Distribution Algorithm 1608 can be used in online educational platforms focusing on test preparation. The algorithm is utilized within a digital learning environment where students are preparing for AP exams. It distributes learning content based on the weightage of each standard in the actual exam, optimizing study sessions to focus on areas that will most impact the student's exam score. In one of the embodiments, the Exam Proportionate Content Distribution Algorithm can be adapted for use in preparing for other standardized tests like the SAT, GRE, or professional certification exams where content weightage is known.

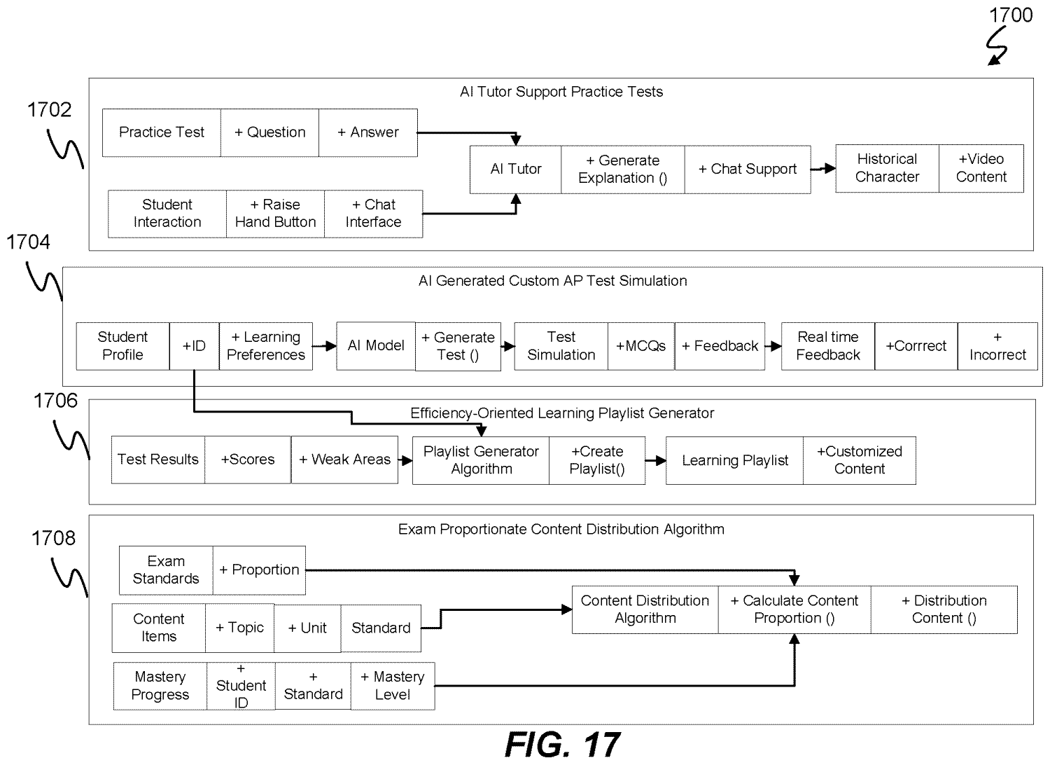

FIG. 17 shows an AI-generated mock test 108 and an accelerated learning process 1700, which is an embodiment of the personalized content generation process 200 in FIG. 2.

The AI-generated mock test 108 and accelerated learning process 1700 illustrate a comprehensive framework consisting of four interconnected subsystems, each dedicated to enhancing various aspects of educational content delivery and user support. The AI-generated mock test 108 and accelerated learning process 1700 are organized into steps, each representing a distinct module with specialized functions.

The AI-generated mock test 108 simulation step focuses on distributing educational content in proportion to exam standards. It includes nodes such as ExamStandards, ContentItems, and MasteryProgress. The ExamStandards node details the proportion of content required based on various exam criteria. ContentItems organizes educational materials by topic, unit, and standard, while MasteryProgress tracks each user's understanding and mastery level across these standards. The ContentDistributionAlgorithm node synthesizes this information, using the CalculateContentProportion( ) and DistributeContent( ) functions to allocate content appropriately, ensuring that the study materials align with both curriculum requirements and individual user needs.

The real-time tutor 110 guidance step is dedicated to simulating Advanced Placement (AP) tests using AI technology. The AIModel node generates tests based on data from the UserProfile, which includes each user's ID and mastery levels. The generated test, housed in the TestSimulation node, features multiple-choice questions (MCQs) and provides immediate feedback. This feedback, categorized as correct, incorrect, or supplemented with hints, is delivered through the RealTimeFeedback node, offering users insights into their performance and guiding their study efforts.

The playlist generation step utilizes the playlist generator 146 to provide real-time support during practice tests. The PracticeTest node captures the questions and answers, triggering the AITutor to generate explanations and offer chat support. The real-time tutor 110 can refer users to HistoricalCharacter, a node containing video content that adds a multimedia dimension to the learning experience. Additionally, the UserInteraction node allows users to engage via a Raise Hand Button and a Chat Interface, ensuring that they receive timely help and clarification on challenging topics.

This step is centered around creating efficient, personalized learning playlists. The TestResults node records scores and identifies weak areas for each user. Using data from the UserProfile, which details individual learning preferences, the PlaylistGeneratorAlgorithm node crafts customized learning playlists. The CreatePlaylist( ) function ensures that the content in the LearningPlaylist is in correspondence to address the user's specific weaknesses and learning style, optimizing the study experience and improving knowledge retention.

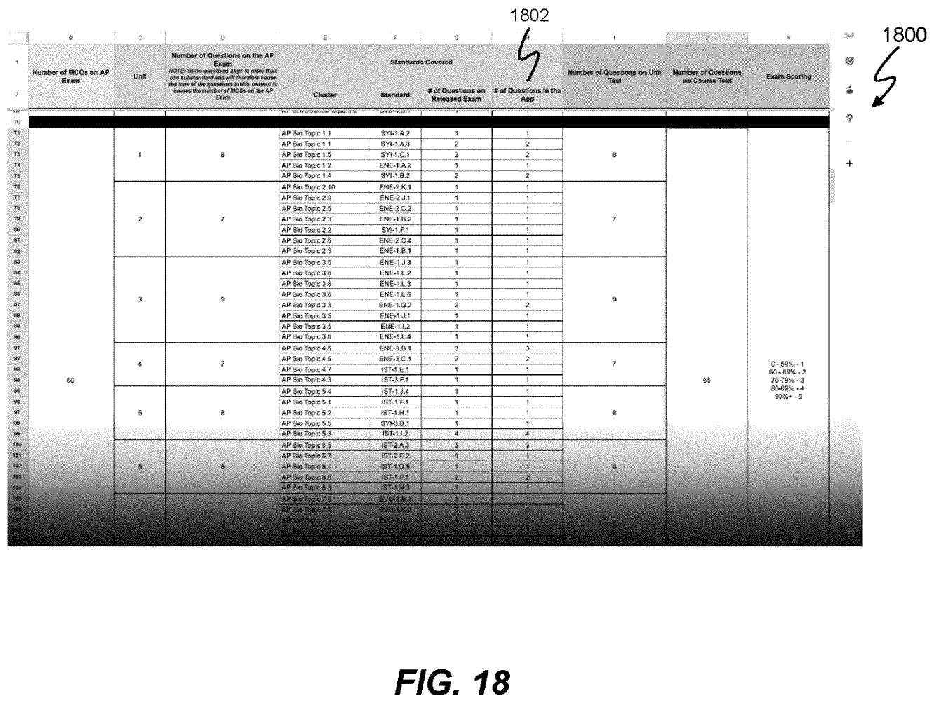

FIG. 18 depicts an exemplary exam data 1800 displaying the number of questions that appeared in one or more previous exams.

The exam data 1800 provides the relation of these questions with respective standards related to the underlined course. This is the exemplary exam data used to calculate the weightage of these questions based on which the mock test 108 is created.

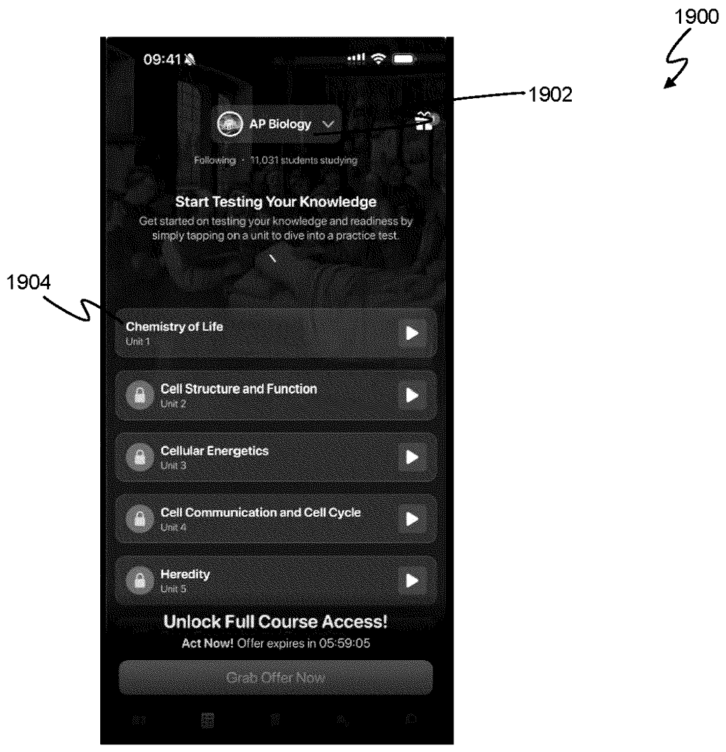

FIG. 19 depicts an exemplary user interface 1900 disclosing the topic-wise details of the subject.

The user interface 1900 can be accessed by the user using the online learning platform 102. The standard 1902 i.e., ‘AP Biology’ is selected by the user to access the details. The units 1904 available in the standard 1902 are shown in the user interface 1900. The user can select the unit of his/her choice and either choose the study mode or the test prep mode 106.

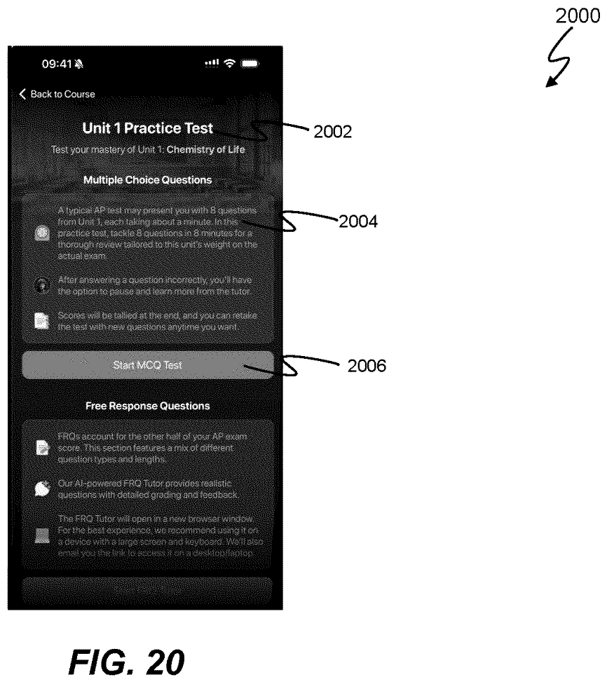

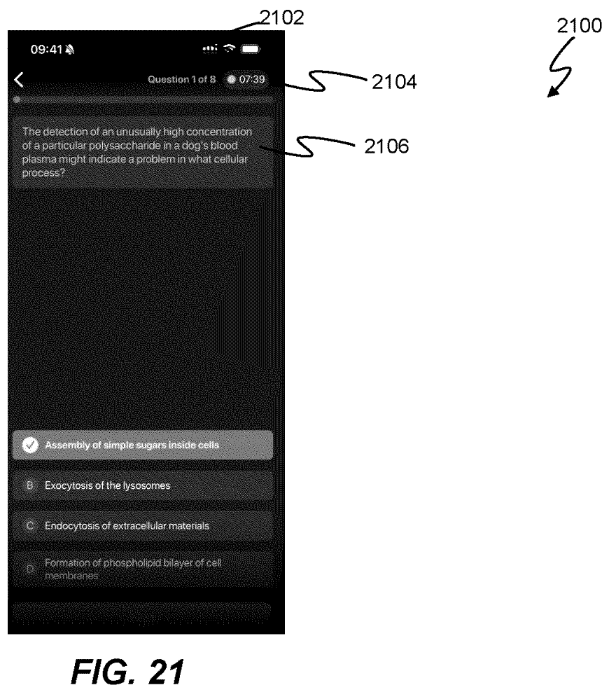

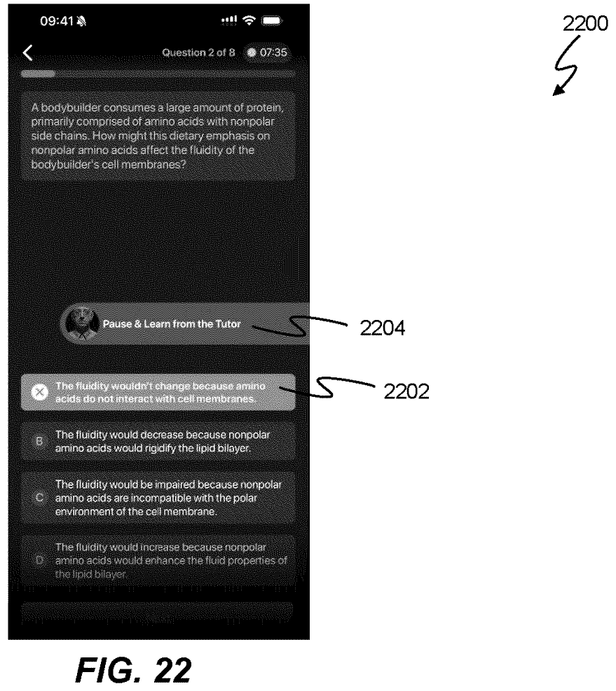

FIGS. 20-22 depict exemplary user interfaces disclosing the AI-generated mock test 108 to the user using an online learning platform 102.

The user interface 2000 displays the front page of the practice test or mock test 108 in the online learning platform 102. The user interface 2000 displays the basic details of the practice test 2002. The details include the number of questions from each unit and the time required 2004 to complete the test. The user can click on the tab 2006 “Start MCQ test” to open the mock test.

The user interface 2100 displays the number of questions 2102 which will be presented to the user in the mock test 108. The user interface 2100 also displays the timer 2104 so that the user is aware of the time left to solve the pending questions. As shown, the user is required to answer 8 questions within 8 minutes in this mock test. The user is presented with a multiple choice question 2106. Upon answering the question correctly the user is taken to the next question.

The user interface 2200 displays that the user has given an incorrect answer 2202 to the multiple choice question 2106. As the user answers the question incorrectly 2202 a pop-up 2204 tab is displayed. The user can click on the pop-up 2204 tab which says “pause & learn from the tutor”. The timer on the interface stops as the user will be taken to a different user interface 2300, where the real-timeAI-110 tutor will guide the user.

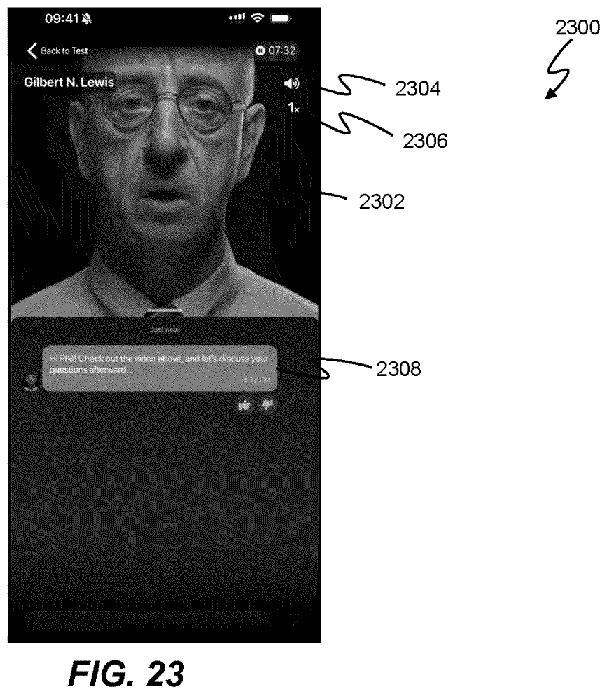

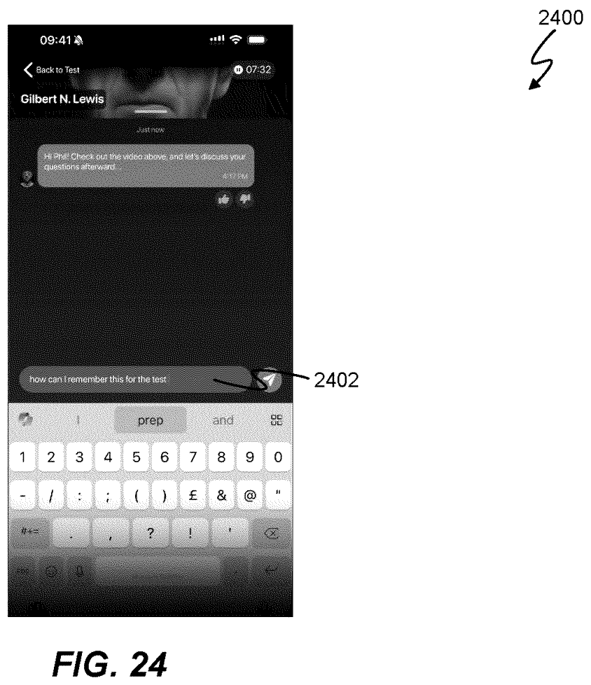

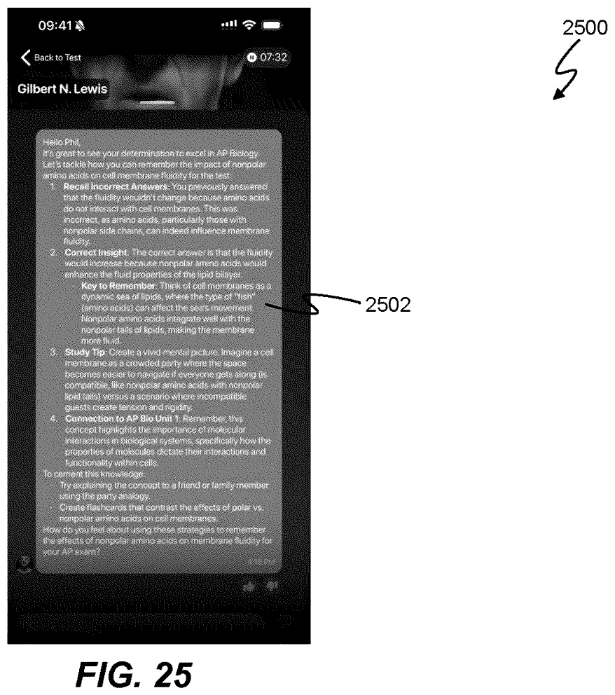

FIGS. 23-25 depict exemplary user interfaces disclosing a real-time tutor 110 assisting the user in real-time when the user gives an incorrect answer during a mock test 108.

The user interface 2300 represents a real-time tutor 2302. The real-time tutor 2302 explains the concept related to the question that the user answers incorrectly. The user interface 2300 provides various interactive buttons 148 such that the user can mute the voice 2304, and increase or decrease the playback speed 2306 of the video. A message 2308 is also provided at the bottom of the user interface 2300. For example, when a user is watching a video, a message is displayed “Check the video above, and let's discuss your questions afterward. After watching the video if the user has some doubts, he/she can interact with the real-time tutor 2302 in real-time.

The user interface 2400 represents a chat interaction between the user and the real-time tutor 2302. The user interacts with the real-time tutor 2302 using a chatbot 2402. The user can type the doubt or question in the chatbot, for example, “how can i remember this for the test”, and so on.

The user interface 2500 represents the response 2502 provided by a real-time tutor 2302 when the user gives an incorrect answer. The real-time tutor 2302 will provide some ideas on how to remember, for instance, in this case “the impact of non-polar amino acids on cell membrane fluidity” for the test. The real-time tutor 2302 will provide insights and study tips and will ask the user at the end of the chat if the user has any doubts. In this way, the real-time tutor 2302 allows the users to clear their misunderstandings for that particular standard. Each time a user answers a question incorrectly, the user can pause the test and learn from the real-time tutor 2302.

The user further resumes the test once he/she clears the misunderstanding related to the question that the user got incorrect and attempts the remaining questions to complete the test.

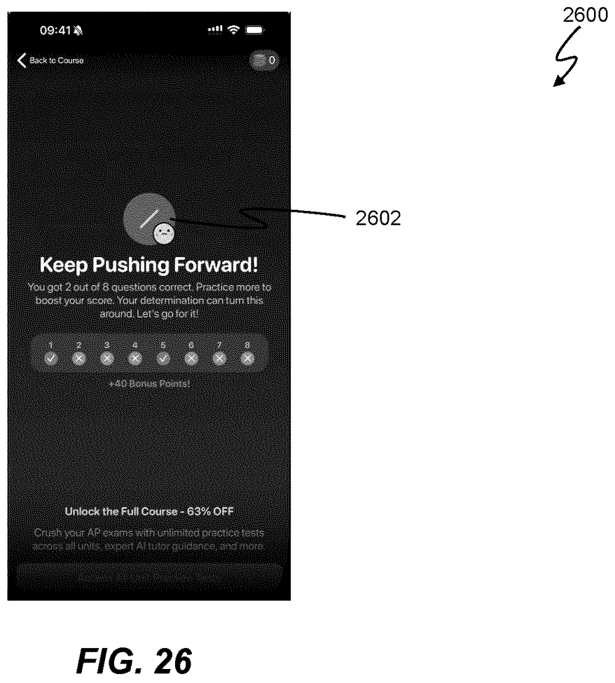

FIG. 26 depicts an exemplary user interface 2600 disclosing the result of the mock test 108 provided to the user.

The user interface 2600 shows the completion of the mock test 108 by displaying the results of the mock test 108 given by the user. The user interface 104 provides a summary of the mock test 108. Grades are provided at the end of the test. The gray circle 2602 represents that the user has got less than 50 percent indicating most of the questions answered by the user are incorrect. If the user scores 50 percent the user gets a grade 3 and so on.

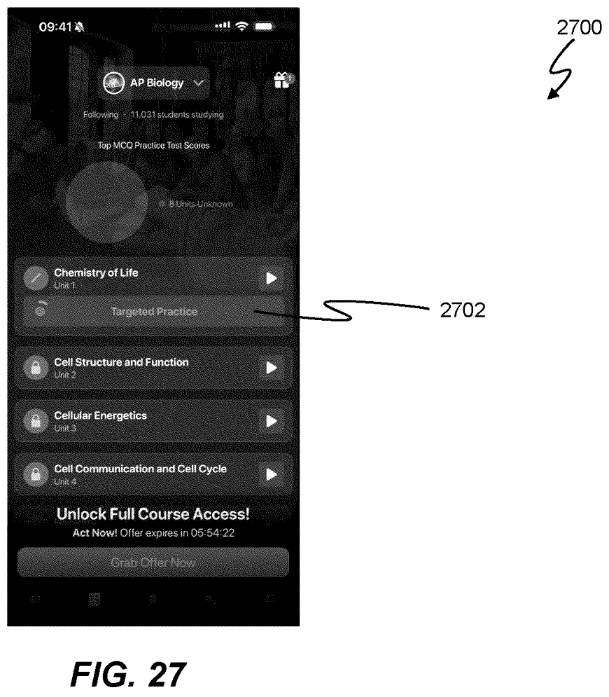

FIGS. 27-29 depict exemplary user interfaces disclosing the targeted personalized content to the user after finishing the mock test 108, based on the incorrect answers and their weightage in the curriculum.

FIG. 27 depicts an exemplary user interface 2700 representing a targeted practice. Based upon the questions answered incorrectly by the user, a targeted practice 2702 mode is developed which provides content targeted to the user's weaker areas to enhance the learning of the user.

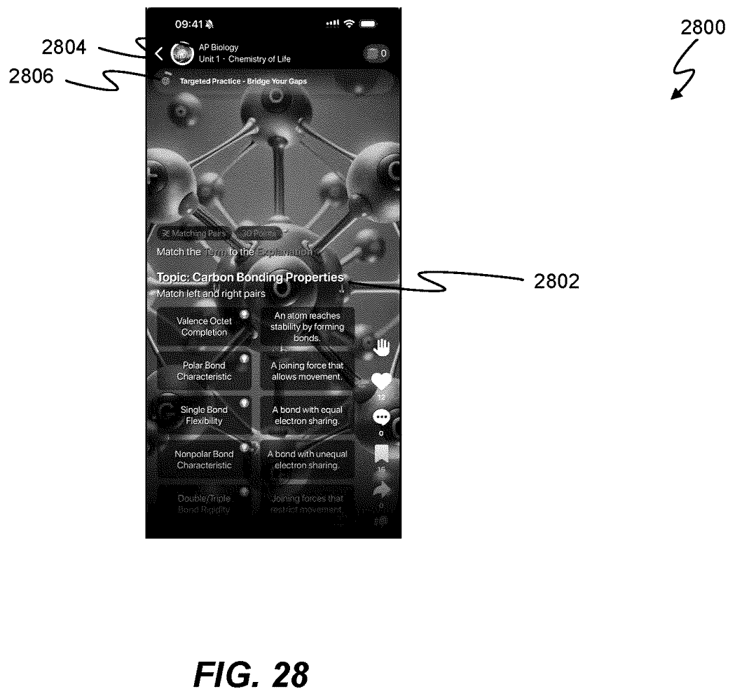

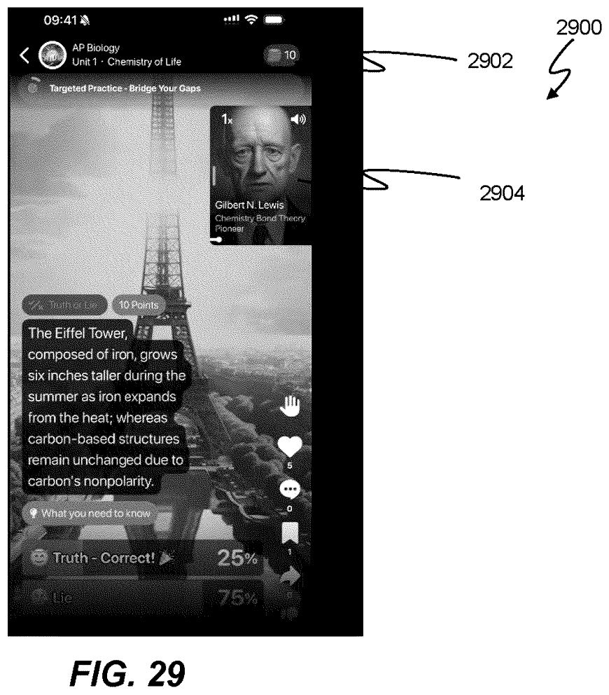

FIGS. 28-29 depict exemplary user interfaces 2800 and 2900 representing the personalized content provided to the user based on his performance in the mock test. The user interface 2800 represents the personalized content indicating the understanding of the topic carbon bonding properties 2802 within the AP biology 2304 unit. The user interacts with the content and enhances his understanding of the particular topic. The orange circle 2806 represents the progress towards completing the targeted practice. The user interface 2900 represents the video content to explain the content. The top right of the user interface 2900 represents the bonus points the user receives as he/she proceeds forward in the personalized content 138. The real-time tutor 2904 appears on the user interface 2900 to explain the particular concept if the user answers the question incorrectly.

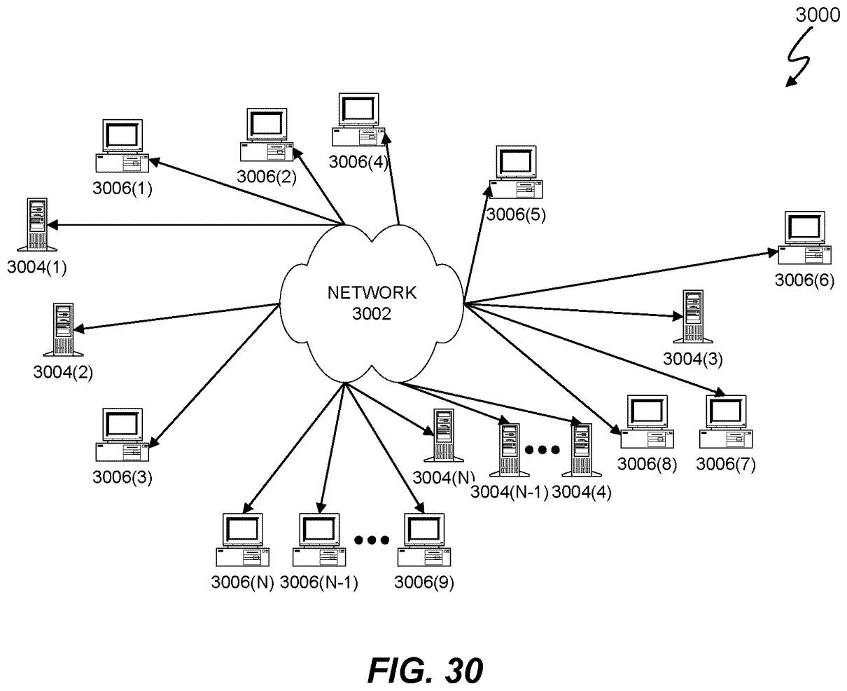

FIG. 30 is a block diagram illustrating a network environment in which a personalized content generation system 100 and personalized content generation process 200 for accelerated exam preparation based on the mastery level of the user on various educational standards and the weightage of the educational standards may be practiced. Network 3002 (e.g. a private wide area network (WAN) or the Internet) includes several networked server computer systems 3004(1)-(N) that are accessible by client computer systems 3006(1)-(N), where N is the number of server computer systems connected to the network. Communication between client computer systems 3006(1)-(N) and server computer systems 3004(1)-(N) typically occurs over a network, such as a public switched telephone network over asynchronous digital subscriber line (ADSL) telephone lines or high-bandwidth trunks, for example, communications channels providing T1 or OC3 service. Client computer systems 3006(1)-(N) typically access server computer systems 3004(1)-(N) through a service provider, such as an internet service provider (“ISP”) by executing application-specific software, commonly referred to as a browser, on one of client computer systems 3006(1)-(N).

Client computer systems 3006(1)-(N) and/or server computer systems 3004(1)-(N) are specialized computers programmed to improve conventional computer systems to implement and utilize the personalized content generation system 100 and personalized content generation process 200 for accelerated exam preparation based on the mastery level of the user on various educational standards and the weightage of the educational standards. The type of computer system that can be specially programmed to implement and utilize the personalized content generation system 100 and personalized content generation process 200 for accelerated exam preparation based on the mastery level of the user on various educational standards and the weightage of the educational standards includes a mainframe, a mini-computer, a personal computer system including notebook computers, a wireless, mobile computing device (including personal digital assistants, smartphones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the personalized content generation system 100 and personalized content generation process 200 for accelerated exam preparation based on the mastery level of the user on various educational standards and the weightage of the educational standards can be implemented using code stored in a tangible, non-transient computer-readable medium and executed by one or more processors. In at least one embodiment, the personalized content generation system 100 and personalized content generation process 200 for accelerated exam preparation based on the mastery level of the user on various educational standards and the weightage of the educational standards can be implemented completely in hardware using, for example, logic circuits and other circuits including field programmable gate arrays.

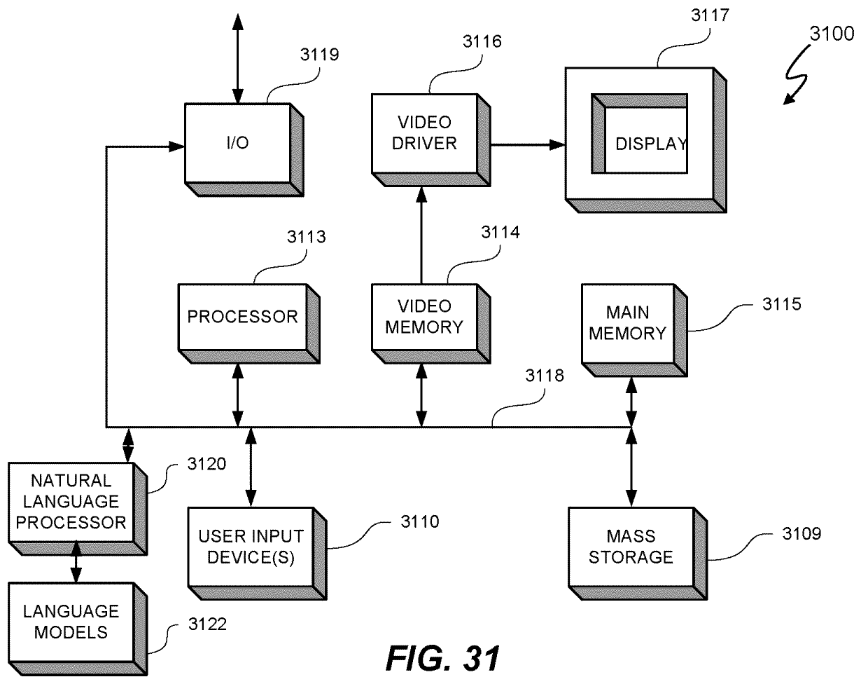

Embodiments of the personalized content generation system 100 and personalized content generation process 200 for accelerated exam preparation based on the mastery level of the user on various educational standards and the weightage of the educational standards can be implemented on a computer system such as a special-purpose, special-programmed computer 3100 illustrated in FIG. 31. The input user device(s) 2810, such as a keyboard and/or mouse, are coupled to a bi-directional system bus 3118. The input user device(s) 3110 are for introducing user input to the computer system and communicating that user input to processor 3113. The computer system of FIG. 31 generally also includes a non-transitory video memory 3114, non-transitory main memory 3115, and non-transitory mass storage 3109, all coupled to bi-directional system bus 3118 along with input user device(s) 3110 and processor 3113. The mass storage 3109 may include fixed and removable media, such as a hard drive, one or more CDs or DVDs, solid state memory including flash memory, and other available mass storage technology. Bus 3118 may contain, for example, 32 of 64 address lines for addressing video memory 3114 or main memory 3115. The system bus 3118 also includes, for example, an n-bit data bus for transferring DATA between and among the components, such as CPU 3109, main memory 3115, video memory 3114, and mass storage 3109, where “n” is, for example, 32 or 64. Alternatively, multiplex data/address lines may be used instead of separate data and address lines.

I/O device(s) 3119 may provide connections to peripheral devices, such as a printer, and may also provide a direct connection to a remote server computer systems via a telephone link or to the Internet via an ISP. I/O device(s) 3119 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection, or the like. Examples of I/O devices include modems, sound and video devices, and specialized communication devices such as the aforementioned network interface.

Computer programs and data are generally stored as code in a non-transient computer-readable medium such as flash memory, optical memory, magnetic memory, compact disks, digital versatile disks, and any other type of memory. The computer program is loaded from a memory, such as mass storage 3109, into main memory 3115 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 3113, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 3115 is comprised of dynamic random access memory (DRAM). Video memory 3114 is a dual-ported video random access memory. One port of the video memory 3114 is coupled to the video amplifier 3116. The video amplifier 3116 is used to drive the display 3117. Video amplifier 3116 is well-known in the art and may be implemented by any suitable means. This circuitry converts pixel DATA stored in video memory 3114 to a raster signal suitable for use by display 3117. Display 3117 is a type of monitor suitable for displaying graphic images.

The computer system described above is for purposes of example only. The personalized content generation system 100 and personalized content generation process 200 for accelerated exam preparation based on the mastery level of the user on various educational standards and the weightage of the educational standards may be implemented in any type of computer system or programming or processing environment. It is contemplated that the personalized content generation system 100 and personalized content generation process 200 for accelerated exam preparation based on the mastery level of the user on various educational standards and the weightage of the educational standards might be run on a stand-alone computer system, such as the one described above. The personalized content generation system 100 and personalized content generation process 200 for accelerated exam preparation based on the mastery level of the user on various educational standards and the weightage of the educational standards might also be run from a server computer system that a plurality of client computer systems can access interconnected over an intranet network. Finally, the personalized content generation system 100 and personalized content generation process 200 for accelerated exam preparation based on the mastery level of the user on various educational standards and the weightage of the educational standards may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method of guiding and constraining an Artificial Intelligence (AI) engine to generate personalized educational content for accelerating test preparation of a user based on the performance of a user in a mock test on an online learning platform, the method comprises:
executing code using one or more processors of a computer system to cause the computer system to perform operations comprising:
presenting the mock test via a user interface on the online learning platform, wherein the mock test includes multiple questions related to a selected teaching curriculum;
receiving user performance data including the performance of the user on the mock test and mastery data indicating the level of mastery obtained by the user on various topics included in the teaching curriculum, wherein the mastery data is based on the topics studied by the user before attempting the mock test;
mapping the user performance data to exam data, wherein the exam data includes multiple questions and corresponding topics that appeared in one or more previous exams, thereby identifying one or more weak topics that are not yet mastered by the user but are important from an exam standpoint;
identifying the weightage of one or more weak topics based on the frequency of occurrence of the weak topics in previous exams and the relevance of weak topics to one or more standards of the teaching curriculum;
generating prompts to guide and constrain the AI engine based on the identified weak areas to generate personalized content for accelerated exam preparation;
transferring the prompts to the AI engine to generate the personalized content for the user on a real-time basis;
receiving the personalized content for the user from the AI engine, wherein the generated personalized content includes content related to the topics where the mastery level of the user is low, but the weightage of the topic to come in the exam is high.

2. The method of claim 1 wherein the generated personalized content is presented in an order defined based on the identified weightage of one or more weak topics such that a weak topic having higher weightage is presented first as compared to another weak topic with lower weightage.

3. The method of claim 1 wherein identifying one or more weak topics further comprises identifying the questions that are incorrectly answered by the user and the relevance of the topic concerning their frequency of occurrence in previous exams.

4. The method of claim 1 wherein the generated personalized content includes practice questions related to one or more weak topics.

5. The method of claim 1 further comprises:
prioritizing educational content for topics with low mastery levels and high curriculum weightage, ensuring that users focus on the most impactful areas first;
dynamically adjusting the frequency and volume of the delivery of the educational content item with more frequent and detailed materials provided for high-weightage, low-mastery topics, while maintaining a balanced approach for other areas to ensure comprehensive coverage of the curriculum.

6. The method of claim 1 wherein a real-time tutor appears and guides the user when the user provides an incorrect answer to the questions presented to the user in the mock test or when the user asks for guidance via an interactive button during a learning session.

7. The method of claim 6 wherein the interactive button is integrated within the user interface of the online learning platform, which can be used by the user whenever the user faces difficulty while understanding a topic.

8. The method of claim 1 wherein the real-time tutor is a virtual character with detailed knowledge of the educational content presented to the user and is integrated within the online learning platform.

9. The method of claim 1 wherein generating the personalized content comprises:
receiving user data including the user's test results, which may include scores, performance metrics, or other relevant data points obtained through the mock test;
utilizing machine learning algorithms for analyzing the user's performance data to identify weak areas and the topics where the user needs to improve;
compiling personalized learning content consisting of learning materials, resources, and activities targeting the identified weak topics;
prioritizing the topics within the generated content based on the level of mastery of the weak topics.

10. The method of claim 1 further comprises:
tracking user engagement data such as time spent on each topic, number of attempts per question, and interaction with the educational content;
identify the user's weak areas by analyzing the user engagement data to optimize content delivery.

11. The method of claim 1 wherein the user can provide feedback on the educational content and the response generated by the real-time tutor on the online learning platform that includes text-based comments, ratings, and suggestions.

12. The method of claim 1 wherein NLP (Natural Language Processing) techniques are used to analyze the text-based feedback and generate insights to integrate user feedback into iterative updates and enhancements of educational content, learning materials, and platform features to enhance user experience and learning outcomes.

13. A system to guide and constrain an Artificial Intelligence (AI) engine to generate personalized educational content for accelerating test preparation of a user based on the performance of a user in a mock test on an online learning platform comprises:
one or more processors;
a memory, coupled to the one or more processors, that stores code that when executed causes the one or more processors to perform operations comprising:
presenting a mock test via a user interface on the online learning platform, wherein the mock test includes multiple questions related to a selected teaching curriculum;
receiving user performance data including the performance of the user on the mock test and mastery data indicating the level of mastery obtained by the user on various topics included in the teaching curriculum using data collector, wherein the mastery data is based on the topics studied by the user before attempting the mock test;
mapping the user performance data to exam data using a mapping module, wherein the exam data includes multiple questions and corresponding topics that appeared in one or more previous exams, thereby identifying one or more weak topics that are not yet mastered by the user but are important from an exam standpoint;
identifying the weightage of one or more weak topics based on the frequency of occurrence of the weak topics in previous exams and the relevance of weak topics to one or more standards of the teaching curriculum using a weightage calculation module;
generating prompts using a prompt generator to guide and constrain the AI engine based on the identified weak areas to generate personalized content for accelerated exam preparation;
transferring the prompts to the AI engine to generate the personalized content for the user on a real-time basis;
receiving the personalized content for the user from a personalized content generation module, wherein the generated personalized content includes content related to the topics where the mastery level of the user is low, but the weightage of the topic to come in the exam is high.

14. The system of claim 13 wherein a real-time tutor appears and guides the user when the user provides an incorrect answer to the content provided to the user or when the user asks for guidance via an interactive button.

15. The system of claim 13 wherein the generated personalized content is presented in an order defined based on the identified weightage of one or more weak topics such that a weak topic with higher weightage is presented first compared to another weak topic with lower weightage.

16. The system of claim 13 wherein identifying one or more weak topics further comprises identifying the questions that are incorrectly answered by the user and the relevance of the topic concerning their frequency of occurrence in previous exams.

17. The system of claim 13 wherein the generated personalized content includes practice questions related to one or more weak topics.

18. The system of claim 13 further comprises:
prioritizing educational content for topics with low mastery levels and high curriculum weightage, ensuring that users focus on the most impactful areas first;
dynamically adjusting the frequency and volume of the delivery of the educational content item with more frequent and detailed materials provided for high-weightage, low-mastery topics, while maintaining a balanced approach for other areas to ensure comprehensive coverage of the curriculum.

19. The system of claim 13 wherein a feedback module allows the user to provide feedback on the generated personalized content and the guidance provided by the real-time tutor during a learning session on the online learning platform.

20. The system of claim 13 wherein generating the personalized content comprises:
receiving user data including the user's test results, which may include scores, performance metrics, or other relevant data points obtained through the mock test;
utilizing machine learning algorithms for analyzing the user's performance data to identify weak areas and the topics where the user needs to improve;
compiling personalized learning content consisting of learning materials, resources, and activities targeting the identified weak topics; and
prioritizing the topics within the generated content based on the level of mastery of the weak topics.

21. The system of claim 13 further comprises:
tracking user engagement data such as time spent on each topic, number of attempts per question, and interaction with the educational content; and
identify the user's weak areas by analyzing the user engagement data to optimize content delivery.

22. The system of claim 13 wherein NLP (Natural Language Processing) techniques are used to analyze the text-based feedback and generate insights to integrate user feedback into iterative updates and enhancements of educational content, learning materials, and platform features to enhance user experience and learning outcomes.
